(19) United States
(12) Patent Application Publication
(10) Pub. No.: US 2025/0230315 A1
(43) Pub. Date: Jul. 17, 2025

(54) MULTILAYER SHRINKABLE POLYESTER FILMS WITH IMPROVED TOUGHNESS

(71) Applicant: Eastman Chemical Company, Kingsport, TN (US)

(72) Inventors: Huamin Hu, Johnson City, TN (US); Mark Allen Peters, Telford, TN (US); Kayla Breanne Brickey, Poulsbo, WA (US); Brian Michael King, Jonesborough, TN (US); Michael Gage Armstrong, Johnson City, TN (US); Michael Keith Coggins, Jonesborough, TN (US)

(73) Assignee: Eastman Chemical Company, Kingsport, TN (US)

(21) Appl. No.: 18/853,449

(22) PCT Filed: Apr. 5, 2023
(86) PCT No.: PCT/US2023/065351

§ 371 Date: Oct. 2, 2024

Related U.S. Application Data
(60) Provisional application No. 63/362,571, filed on Apr. 6, 2022.

(51) Int. Cl. C08L 67/02; B32B 27/08; B32B 27/36

(52) U.S. Cl. CPC C08L 67/02; B32B 27/08; B32B 27/36; B32B 2250/03; B32B 2250/244; B32B 2250/40; B32B 2270/00; B32B 2307/30; B32B 2307/54; B32B 2307/736; C08L 2203/162; C08L 2205/025; C08L 2207/20

(57) ABSTRACT

Heat shrinkable films comprised of polyesters comprising certain combinations of glycols and diacids in particular proportions. These polyesters afford certain advantageous properties in the resulting shrinkable films including toughness and/or ageing, and thus are suitable as replacements for commercially available shrink films made using poly(vinyl chloride).

### FIELD OF THE INVENTION

The present disclosure relates generally to multilayer shrinkable polyester films comprising polyesters comprising a combination of certain diacid and diol residues in certain compositional ranges having improved properties.

### BACKGROUND OF THE INVENTION

Thermoshrinkable plastic films are used as coverings, to hold objects together, and as an outer wrapping for bottles, cans and other kinds of containers. For example, such films are used for covering the cap, neck, shoulder or bulge of bottles or the entire bottle for the purpose of labeling, protection, parceling, or increasing the value of the product. The uses mentioned above take advantage of the shrinkability created by the internal shrink stress of the film. The films must be tough, must shrink in a controlled manner, and must provide enough shrink force to hold itself on the bottle without crushing the contents. Thermoshrinkable films can be made from a variety of raw materials to meet a range of material demands.

One of the most widely used starting materials for the manufacture of shrinkable plastic films is poly(vinyl chloride) (PVC) and a smaller but significant quantity of shrinkable films are made from oriented polystyrene (OPS). Historically, shrinkable films made with PVC or OPS were used because of the combination of their price and performance. From a performance perspective, PVC-based and OPS-based shrinkable films have a slow shrink rate, a low shrink force, an early onset shrinkage temperature, and a low ultimate or maximum shrinkage. Shrinkable films made with OPS and PVC can be applied to poly(ethylene terephthalate) PET containers but are often used on high-density polyethylene (HDPE) containers where the shrink rate, the onset of shrinkage temperature, and the shrink force are critical to the application. Shrinkable films made with these materials are well-suited to be applied to bottles using a hot air shrink tunnel, where high temperatures and large temperature gradients are commonly present. This film performance criteria is thus advantageously matched with simple bottle designs for moisture-sensitive products like nutraceuticals and pharmaceuticals where the label is commonly applied using a hot air shrink tunnel to package moisture-sensitive products.

Polyester shrink film compositions have been used commercially to produce shrink film labels for food, beverage, personal care, household goods, etc. Polyester compositions can be designed such that shrinkable films made with these resins have a range of favorable performance criteria. Polyester-based shrinkable films can be designed to shrink rapidly between 65° and 80° C., have minimal shrinkage in the direction orthogonal to the main shrinkage direction, to have a maximum shrinkage greater than 70%, and to have a reasonable shrink force. Polyester-based thermoshrinkable film compositions have been used commercially as shrink film labels for food, beverage, personal care, household goods, etc. Often, these shrink films are used in combination with a clear polyethylene terephthalate (PET) bottle or container.

Historically, multilayer shrinkable films which have an inner layer of polystyrene and outer layers of polyester (often referred to as “Hybrid” films) have been developed to combine the best of both materials, but these multilayer films often require an adhesive interlayer to bond the outer and inner layers to one another. These multilayer films require special processing equipment during manufacture, special adhesive tie-layers to bond the outer and inner layers (to minimize delamination) and cannot be reused or recycled due to the heterogenous structure of the film. These films possess a combination of favorable OPS properties and polyester properties (low onset of shrinkage temperature, low shrink force, low shrink rate, and high ultimate shrinkage). These films have been used in applications where a complicated bottle design (e,g., wide base and narrow neck) made from HDPE is labelled in a hot air tunnel.

Currently, it is highly desirable that consumer packaging materials be made of materials which can be readily recycled, contain recycled material, or be made with materials that are not considered to be harmful to the environment either as a raw material or as a final polymeric materials (styrene, polystyrene, PVC, etc.), as is the case with polyesters. Thus, a need exists for improved shrinkable polyester films having comparable performance to films made with OPS and PVC so they can serve as “drop-in” replacements on current packages and be applied using existing hot air, shrink tunnel equipment. Desired properties for the polyester-based shrink film include the following: (1) a relatively low shrinkage onset temperature, (2) a total shrinkage which increases gradually and in a controlled manner with increasing temperature, (3) a low shrink force to prevent crushing of the underlying container, and (4) an inherent film toughness so as to prevent unnecessary tearing and splitting of the film prior to and after shrinkage. Additionally, providing high ultimate shrinkage (>70%) and improved toughness and/or improved aging performance would be particularly advantageous.

### SUMMARY OF THE INVENTION

The polyesters of the present disclosure are useful in the manufacture of multilayer, heat shrinkable films. The multilayer, heat shrinkable films of the present disclosure are comprised of polyesters comprising certain combinations of glycols and diacids in particular proportions. The polyester compositions and multilayer configurations of the present disclosure provide improved toughness and ageing performance. These polyesters afford certain advantageous properties in the resulting shrinkable films. In certain embodiments, the Tg will be between about 60 and 80° C. The shrinkage of the films in the main shrinkage direction will be less than about 2% at 60° C., between about 5 and 30% at 65° C., and greater than 70% at about 95° C. Additionally, the shrink films advantageously possess a shrink rate of less than 4%/° C. between 65 and 80° C. (The shrink rate is measured by subtracting the transverse direction shrinkage (TD shrinkage, the main shrinkage direction) at 65° C. from the TD shrinkage at 80° C. and then dividing that quantity by 15° C.). The shrink films of the present disclosure also possess a shrink force less than 8 MPa measured at 80° C. (or the stretching temperature) and improved toughness measured via MD elongation at break which exceeds 100% initially, and remains above 100% after ageing the film at 40° C. for at least 3 weeks.

In general, shrinkable polyester film of the present disclosure may be prepared by a method comprising the steps of (a) mixing and polymerizing of dibasic acids with diols to obtain a random reactor-grade copolymer resin; (b) melting and pressing the random copolymer resin or extruding the copolyester resin using typical film extrusion equipment to obtain an unstretched monolayer or multilayer film; (c) stretching the unstretched film in the one direction at temperatures between its Tg and Tg+55° C., and (d) evaluating various film properties (including glass transition temperature (Tg), shrinkage as a function of temperature (shrink curve), and shrink force).

### DETAILED DESCRIPTION OF THE INVENTION

In a first aspect, the present disclosure provides a polyester which comprises:
i. a dicarboxylic acid component comprising:
   1. greater than about 75 mole percent of terephthalic acid residues;
   2, about 0 to about 25 mole percent of residues of 1,4-cyclohexanedicarboxylic acid or succinic acid; and
ii. a diol component comprising:
   1, about 50 to 90 mole percent of ethylene glycol residues; and
   2, about 0 to about 30 mole percent of residues chosen from neopentyl glycol, 1,4-cyclohexanedimethanol; and
   3, about 0 to about 15 mole percent of diethylene glycol residues; and
   4, about 0 to about 20 mole percent of one or more of triethylene glycol, 1,3-propanediol, 1,4-butanediol, and 2-methyl-1,3-propanediol residues;
wherein the total mole percent of the dicarboxylic acid component is 100 mole percent, and wherein the total mole percent of the diol component is 100 percent.

In certain embodiments, the dicarboxylic acid component comprises greater than about 95 mole percent of residues of terephthalic acid, or greater than about 98 mole percent of terephthalic acid, or about 100 mole percent of terephthalic acid. In another embodiment, the dicarboxylic acid component comprises about 8 to about 25 mole percent of residues of 1,4-cyclohexanedicarboxylic acid. In another embodiment, the dicarboxylic acid component comprises about 5 to about 10 mole percent of residues of succinic acid.

In other embodiments, the diol component comprises:
a. about 5 to about 30 mole percent of residues of neopentyl glycol; or
b. about 5 to about 30 mole percent of residues of 1,4-cyclohexanedimethanol; or
c. about 5 to about 20 mole percent of residues of 2-methyl-1,3-propanediol; or

In other embodiments, the diol component comprises about 2 to about 14 mole percent of residues of diethylene glycol. In other embodiments, the diol component comprises about 2 to about 31 mole percent of residues of one or more of triethylene glycol; 1,3-propanediol; 1,4-butanediol; and 2-methyl-1,3-propanediol residues.

In other embodiments, the polyester further comprises about 5 to about 25 mole percent of one or more dicarboxylic acid residues chosen from glutaric, azelaic, sebacic, 1,3-cyclohexanedicarboxylic, adipic acid, hexahydrophthalic acid (HHPA), and isophthalic acids.

In another aspect, the present disclosure provides a shrinkable film, comprising the polyester of any of the above embodiments.

Advantageously, the shrinkable films of the present disclosure exhibit one or more of the following properties:
A. TD shrinkage @60° C.<2%;
B. TD shrinkage @65° C. between 2 and 30%;
C. TD shrinkage @95° C.>70%;
D. Shrink rate<4%/deg C. between 65 and 80° C.;
E. Shrink force<10 MPa, or <8 MPa, or <7 MPa;
F. Tg<80° C.;
G. a break strain percentage of greater than 100% at pull rates of 300 mm/minute, or 100 to 300%, or 100 to 500%, or 100 to 800%, in the machine direction according to ASTM Method D882;
H. a break strain percentage of greater than 100% at pull rates of 300 mm/minute, or 100 to 300%, or 100 to 500%, or 100 to 800%, in the machine direction according to ASTM Method D882 after ageing after ageing the film at 40° C. for at least 3 weeks.

The term “polyester”, as used herein, is intended to include “copolyesters” and is understood to mean a synthetic polymer prepared by the reaction of one or more difunctional carboxylic acids and/or multifunctional carboxylic acids with one or more difunctional hydroxyl compounds and/or multifunctional hydroxyl compounds, for example, branching agents. Typically, the difunctional carboxylic acid can be a dicarboxylic acid and the difunctional hydroxyl compound can be a dihydric alcohol, for example, glycols and diols. The term “glycol” as used herein includes, but is not limited to, diols, glycols, and/or multifunctional hydroxyl compounds, for example, branching agents. The term “residue”, as used herein, means any organic structure incorporated into a polymer through a polycondensation and/or an esterification reaction from the corresponding monomer. The term “repeating unit”, as used herein, means an organic structure having a dicarboxylic acid residue and a diol residue bonded through an ester group. Thus, for example, the dicarboxylic acid residues may be derived from a dicarboxylic acid monomer or its associated acid halides, esters, salts, anhydrides, and/or mixtures thereof. Furthermore, as used herein, the term “diacid” includes multifunctional acids, for example, branching agents. As used herein, therefore, the term “dicarboxylic acid” is intended to include dicarboxylic acids and any derivative of a dicarboxylic acid, including its associated acid halides, esters, half-esters, salts, half-salts, anhydrides, mixed anhydrides, and/or mixtures thereof, useful in a reaction process with a diol to make a polyester. As used herein, the term “terephthalic acid” is intended to include terephthalic acid itself and residues thereof as well as any derivative of terephthalic acid, including its associated acid halides, esters, half-esters, salts, half-salts, anhydrides, mixed anhydrides, and/or mixtures thereof or residues thereof useful in a reaction process with a diol to make a polyester.

The polyesters used in the present disclosure typically can be prepared from dicarboxylic acids and diols which react in substantially equal proportions and are incorporated into the polyester polymer as their corresponding residues. The polyesters of the present disclosure, therefore, can contain substantially equal molar proportions of acid residues (100 mole %) and diol (and/or multifunctional hydroxyl compound) residues (100 mole %) such that the total moles of repeating units is equal to 100 mole %. The mole percentages provided in the present disclosure, therefore, may be based on the total moles of acid residues, the total moles of diol residues, or the total moles of repeating units.

In certain embodiments, terephthalic acid or an ester thereof, for example, dimethyl terephthalate or a mixture of terephthalic acid residues and an ester thereof can make up a portion or all of the dicarboxylic acid component used to form the polyesters useful in the present disclosure. In certain embodiments, terephthalic acid residues can make up a portion or all of the dicarboxylic acid component used to form the polyesters useful in this disclosure. For the purposes of this disclosure, the terms “terephthalic acid” and “dimethyl terephthalate” are used interchangeably herein.

Esters of terephthalic acid and the other dicarboxylic acids or their corresponding esters and/or salts may be used instead of the dicarboxylic acids. Suitable examples of dicarboxylic acid esters include, but are not limited to, the dimethyl, diethyl, dipropyl, diisopropyl, dibutyl, and diphenyl esters. In one embodiment, the esters are chosen from at least one of the following: methyl, ethyl, propyl, isopropyl, and phenyl esters.

In one embodiment, at least a portion of the residues derived from dicarboxylic acids and glycols as set forth herein, are derived from recycled monomeric species such as recycled dimethylterephthalate (rDMT), recycled terephthalic acid (rTPA), recycled dimethylisopthalate (rDMI), recycled ethylene glycol (rEG), recycled cyclohexanedimethanol (rCHDM), recycled neopentyl glycol (rNPG), and recycled diethylene glycol (rDEG). Such recycled monomeric species can be obtained from known methanolysis or glycolysis reactions which are utilized to depolymerize various post-consumer recycled polyesters and copolyesters. Similarly, recycled poly(ethylene terephthalate) (rPET) can be utilized as a feedstock (for the dicarboxylic acid and glycol components) in the manufacturing of polyesters of the present disclosure having recycle content. Accordingly, in another embodiment, the polyester compositions of this disclosure comprise at least a portion of the dicarboxylic acid residues and/or glycol residues are derived from (i) recycled monomeric species chosen from rDMT, rTPA, rDMI, rEG, rCHDM, rDEG, rNPG and (ii) rPET.

In one embodiment, the diol component of the polyester compositions useful in the present disclosure can comprise 1,4-cyclohexanedimethanol. In another embodiment, the diol component of the polyesters useful in the present disclosure comprise 1,4-cyclohexanedimethanol and 1,3-cyclohexanedimethanol. The molar ratio of cis/trans 1,4-cyclohexandimethanol can vary within the range of 50/50 to 0/100, for example, between 40/60 to 20/80.

It should be noted that some other diol residues may be formed in situ during processing. The total amount of diethylene glycol residues can be present in the polyester, whether or not formed in situ, in a total amount when present of up to about 15 mole percent.

In some embodiments, the polyesters according to the present disclosure can comprise from 0 to 10 mole %, for example, from 0.01 to 5 mole %, from 0.01 to 1 mole %, from 0.05 to 5 mole %, from 0.05 to 1 mole %, or from 0.1 to 0.7 mole %, based the total mole percentages of either the diol or diacid residues; respectively, of one or more residues of a branching monomer, also referred to herein as a branching agent, having 3 or more carboxyl substituents, hydroxyl substituents, or a combination thereof. In certain embodiments, the branching monomer or agent may be added prior to and/or during and/or after the polymerization of the polyester. In some embodiments, the polyester(s) useful in the present disclosure can thus be linear or branched.

Examples of branching monomers include, but are not limited to, multifunctional acids or multifunctional alcohols such as trimellitic acid, trimellitic anhydride, pyromellitic dianhydride, trimethylolpropane, glycerol, pentaerythritol, citric acid, tartaric acid, 3-hydroxyglutaric acid and the like. In one embodiment, the branching monomer residues can comprise 0.1 to 0.7 mole % of one or more residues chosen from at least one of the following: trimellitic anhydride, pyromellitic dianhydride, glycerol, sorbitol, 1,2,6-hexanetriol, pentaerythritol, trimethylolethane, and/or trimesic acid. The branching monomer may be added to the polyester reaction mixture or blended with the polyester in the form of a concentrate as described, for example, in U.S. Pat. Nos. 5,654,347 and 5,696,176, incorporated herein by reference.

The polyesters of the present disclosure can also comprise at least one chain extender. Suitable chain extenders include, but are not limited to, multifunctional (including, but not limited to, bifunctional) isocyanates, multifunctional epoxides, including, for example, epoxylated novolac polymers, and phenoxy resins. In certain embodiments, chain extenders may be added at the end of the polymerization process or after the polymerization process. If added after the polymerization process, chain extenders can be incorporated by compounding or by addition during conversion processes such as injection molding or extrusion.

The amount of chain extender used can vary depending on the specific monomer composition used and the physical properties desired but is generally about 0.1 percent by weight to about 10 percent by weight, such as about 0.1 to about 5 percent by weight, based on the total weight of the polyester.

It is contemplated that polyesters of the present disclosure can possess at least one of the inherent viscosity ranges described herein and at least one of the monomer ranges for the polyesters described herein, unless otherwise stated. It is also contemplated that polyesters useful in the present disclosure can possess at least one of the Tg ranges described herein and at least one of the monomer ranges for the polyesters described herein, unless otherwise stated. It is also contemplated that polyesters useful in the present disclosure can possess at least one of the inherent viscosity ranges described herein, at least one of the Tg ranges described herein, and at least one of the monomer ranges for the polyesters described herein, unless otherwise stated.

In certain embodiments, the polyesters useful in the present disclosure can exhibit at least one of the following inherent viscosities as determined in 60/40 (weight/weight) phenol/tetrachloroethane at a concentration of 0.25 g/50 ml at 25° C. . . . : 0.50 to 1.2 dL/g; 0.50 to 1.0 dL/g; 0.50 to 0.90 dL/g; 0.50 to 0.80 dL/g; 0.55 to 0.80 dL/g; 0.60 to 0.80 dL/g; 0.65 to 0.80 dL/g; 0.70 to 0.80 dL/g; 0.50 to 0.75 dL/g; 0.55 to 0.75 dL/g; or 0.60 to 0.75 dL/g. In one embodiment, the inherent viscosity is 0.60-0.80.

The glass transition temperature (Tg) of the polyesters is determined using a TA DSC 2920 from Thermal Analyst Instrument at a scan rate of 20° C./minute.

In certain embodiments, the oriented films or shrink films of this disclosure comprise a polyester wherein the polyester has a Tg of 60 to 80° C.; 70 to 80° C.; or 65 to 80° C.; or 65 to 75° C. In one embodiment, the Tg is 60-75° C. In certain embodiments, these Tg ranges can be met with or without at least one plasticizer being added during polymerization.

In one embodiment, the polyesters of the present disclosure can be visually clear. The term “visually clear” is defined herein as an appreciable absence of cloudiness, haziness, and/or muddiness, when inspected visually.

The polyesters useful in this disclosure can be made by processes known from the literature, for example, by processes in homogenous solution, by transesterification processes in the melt, and by two phase interfacial processes. Suitable methods include, but are not limited to, the steps of reacting one or more dicarboxylic acids with one or more diols at a temperature of 100° C. to 315° C. at a pressure of 0.1 to 760 mm Hg for a time sufficient to form a polyester. See U.S. Pat. No. 3,772,405 for methods of producing polyesters, the disclosure regarding such methods is hereby incorporated herein by reference.

The polyester in general may be prepared by condensing the dicarboxylic acid or dicarboxylic acid ester with the diol in the presence of a catalyst at elevated temperatures increased gradually during the course of the condensation up to a temperature of about 225° C. to 310° C., in an inert atmosphere, and conducting the condensation at low pressure during the latter part of the condensation, as described in further detail in U.S. Pat. No. 2,720,507 incorporated herein by reference herein.

In some embodiments, during the process for making the polyesters useful in the present disclosure, certain agents which colorize the polymer can be added to the melt including toners or dyes. In one embodiment, a bluing toner is added to the melt in order to adjust the b* of the resulting polyester polymer melt phase product. Such bluing agents include blue inorganic and organic toner(s) and/or dyes. In addition, red toner(s) and/or dyes can also be used to adjust the a* color. In one embodiment, the polymers useful in this disclosure and/or the polymer compositions of the disclosure, with or without toners, can have color values L*, a and b* which can be determined using a Hunter Lab Ultrascan Spectra Colorimeter manufactured by Hunter Associates Lab Inc., Reston, Va. The color determinations are averages of values measured on either pellets or powders of the polymers or plaques or other items injection molded or extruded from them. They are determined by the L*a*b* color system of the CIE (International Commission on Illumination) (translated), wherein L* represents the lightness coordinate, a* represents the red/green coordinate, and b* represents the yellow/blue coordinate. Organic toner(s), e.g., blue and red organic toner(s), such as those toner(s) described in U.S. Pat. Nos. 5,372,864 and 5,384,377, which are incorporated by reference in their entirety, can be used. The organic toner(s) can be fed as a premix composition. The premix composition may be a neat blend of the red and blue compounds or the composition may be pre-dissolved or slurried in one of the polyester's raw materials, e.g., ethylene glycol.

The total amount of toner components added can depend on the amount of inherent yellow color in the base polyester and the efficacy of the toner. In one embodiment, a concentration of up to about 15 ppm of combined organic toner components and a minimum concentration of about 0.5 ppm can be used. In one embodiment, the total amount of bluing additive can range from 0.5 to 10 ppm. In an embodiment, the toner(s) can be added to the esterification zone or to the polycondensation zone. Advantageously, the toner(s) are added to the esterification zone or to the early stages of the polycondensation zone, such as to a pre-polymerization reactor or added in an extruder

In certain embodiments, the polyester compositions can also contain from 0.01 to 25% by weight of the overall composition common additives such as colorants, dyes, mold release agents, flame retardants, plasticizers, glass bubbles, voiding agents, nucleating agents, stabilizers, including but not limited to, UV stabilizers, thermal stabilizers, and/or reaction products thereof, fillers, and impact modifiers. Examples of commercially available impact modifiers include, but are not limited to, ethylene/propylene terpolymers, functionalized polyolefins such as those containing methyl acrylate and/or glycidyl methacrylate, styrene-based block copolymeric impact modifiers, and various acrylic core/shell type impact modifiers. Residues of such additives are also contemplated as part of the polyester composition.

In another aspect, this disclosure provides shrink film(s) and molded article(s) of this disclosure comprising the polyesters as described herein. The methods of forming the polyesters into film(s) and/or sheet(s) are well known in the art. Examples of film(s) and/or sheet(s) useful the present disclosure include but not are limited to extruded film(s) and/or sheet(s), compression molded film(s), calendered film(s) and/or sheet(s), solution casted film(s) and/or sheet(s). In one aspect, methods of making film and/or sheet useful to produce the shrink films of the present disclosure include but are not limited to extrusion, compression molding, calendering, and solution casting.

Accordingly, in another aspect, this disclosure provides a molded article, thermoformed sheet, extruded sheet or film, comprising the polyesters of the various embodiments herein.

The shrink films of the present disclosure can have an onset of shrinkage temperature of from about 55 to about 80° C., or about 55 to about 75° C., or about 55 to about 70° C. Onset shrinkage temperature is the lowest temperature at which shrinkage occurs.

In certain embodiments, the polyesters of the present disclosure can have densities of 1.6 g/cc or less, or 1.5 g/cc or less, or 1.4 g/cc or less, or 1.1 g/cc to 1.5 g/cc, or 1.2 g/cc to 1.4 g/cc, or 1.2 g/cc to 1.35 g/cc. In one embodiment, the polyesters of this disclosure have densities of 1.2 g/cc to 1.3 g/cc.

One approach for reducing the density is to introduce many small voids or holes into the shaped article. This process is called “voiding” and may also be referred to as “cavitating” or “microvoiding”. Voids are obtained by incorporating about 5 to about 50 weight % of small organic or inorganic particles or “inclusions” (referred in the art as “voiding” or “cavitation” agents) into a matrix polymer and orienting the polymer by stretching in at least one direction. Additionally, the use of immiscible or incompatible resins can create voids. During stretching, small cavities or voids are formed around the voiding agent. When voids are introduced into polymer films, the resulting voided film not only has a lower density than the non-voided film, but also becomes opaque and develops a paper-like surface. This surface also has the advantage of increased printability; that is, the surface is capable of accepting many inks with a substantially greater capacity over a non-voided film. Typical examples of voided films are described in U.S. Pat. Nos. 3,426,754; 3,944,699; 4,138,459; 4,582,752; 4,632,869; 4,770,931; 5,176,954; 5,435,955; 5,843,578; 6,004,664; 6,287,680; 6,500,533; 6,720,085; each of which is incorporated herein by reference, along with U.S. Patent Application Publication Numbers 2001/0036545; 2003/0068453; 2003/0165671; 2003/0170427; Japan Patent Application No.'s 61-037827; 63-193822; 2004-181863; European Patent No. 0 581 970 B1, and European Patent Application No. 0 214 859 A2.

In certain embodiments, the as-extruded films are oriented while they are stretched. The oriented films or shrinkable films of the present disclosure can be made from films having any thickness depending on the desired end-use. The desirable conditions are, in one embodiment, where the oriented films and/or shrinkable films can be printed with ink for applications including labels, photo films which can be adhered to substrates such as paper, and/or other applications that it may be useful in. It may be desirable to coextrude the polyesters useful in the present disclosure with another polymer, such as PET, to make multilayer films useful in making the oriented films and/or shrink films of this disclosure. One advantage of doing the latter is that a tie layer may not be needed in some embodiments. Another advantage of a multilayer film is that is combines the performance of dissimilar materials into a single structure.

In some embodiments, a tie layer is used between the core layers and skin layers. In these embodiments, suitable tie layers comprise one or more copolymers selected from polyethylene copolymers, polypropylene copolymers, anhydride modified polyolefins, acid/acrylate modified ethylene vinyl acetate copolymer, acid modified ethylene acrylate, anhydride modified ethylene acrylate, modified ethylene acrylate, modified ethylene vinyl acetate, anhydride modified ethylene vinyl acetate copolymer, anhydride modified high density polyethylene, anhydride modified linear low density polyethylene, anhydride modified low density polyethylene, anhydride modified polypropylene, ethylene ethyl acrylate maleic anhydride copolymer and ethylene butyl acrylate maleic anhydride terpolymer, ethylene-alpha-olefin copolymers, alkene-unsaturated carboxylic acid or carboxylic acid derivative copolymers, ethylene-methacrylic acid copolymers, ethylene-vinyl acetate copolymers, ethylene-methacrylic acid copolymers, unsaturated dicarboxylic acid anhydride grafted copolymers, maleic anhydride grafted ethylene-vinyl acetate copolymers, maleic anhydride grafted polyethylene, styrene-butadiene copolymers, C3 or higher alpha-olefin copolymers having a high alpha-olefin comonomer content, propylene-1-butene copolymers, and mixtures thereof.

In one embodiment, the choice of tie layer resin depends on the compositions of the polymeric films to be bonded and on the adhesive strength required. In one embodiment, a tie layer is required when film layers of dissimilar chemistries are bonded together in an extrusion process. For example, when a polyolefin is bonded to a polyester in a multi-layer film. In one embodiment, non-reactive tie layer resins are used. In one embodiment, the non-reactive tie layer resins include ethylene vinyl acetate (EVA) and ethylene methyl acrylate copolymer (EMAC). In another embodiment, the non-reactive tie layer resins include acid modified olefin copolymers like ethylene acrylic acid (EAA) and ethylene methacrylic acid (EMAA). These resins are typically considered non-reactive since none or only a small portion of the acid groups undergo chemical reactions such as esterification. However, these resins still provide excellent adhesion to many polar polymers because they form strong hydrogen and polar bonds with many polar polymers such as nylon and polyesters. In another embodiment, reactive tie layer resins are used. For example, in one embodiment, a suitable reactive tie layer resin is anhydride modified polyethylene copolymers (AMP). In one embodiment, reactive tie layer resin adhesives are used when polyolefins are bonded to polyamides (nylons) or to ethylene vinyl alcohol copolymers (EVOH) or to polyesters. In these embodiments, the anhydride reacts with amine end groups to form imides and with alcohols to form ester crosslinks. In one aspect, an important parameter to consider is the amount of functionality in the tie resin. In one embodiment, AMPs can also be employed when no chemical reaction between the two resin layers takes place, as it is the case with PET and PVDC. In embodiments, with metalized films or aluminum foils, tie layer resins with acid functionalities are often the best choice. For example, in some embodiments, copolymers of ethylene and acrylic acid and/or methacrylic acid (EAA, EMAA) are employed for these applications which also bond well to nylon, but acrylate modified olefin resins (EMA) are a good choice in embodiments where the film has to adhere to inks and polyesters.

In one embodiment, the monoaxially and biaxially oriented films of the present disclosure can be made from films having a thickness of about 100 to 400 microns, for example, extruded, cast or calendared films, which can be stretched at a ratio of 6.5:1 to 3:1 at a temperature of from the Tg of the film to the Tg+55° C., and which can be stretched to a thickness of 20 to 80 microns. In one embodiment, the orientation of the initial as extruded film can be performed on a tenter frame according to these orientation conditions. The shrink films of the present disclosure can be made from the oriented films as described herein.

In certain embodiments, the shrink films of the present disclosure have gradual shrinkage with little to no wrinkling. In certain embodiments, the shrink films of the present disclosure have no more than 40% shrinkage in the transverse direction per 5° C. temperature increase increment.

In certain embodiments of the disclosure, the shrink films have shrinkage in the machine direction of from 4% or less, or 3% or less, or 2.5% or less, or 2% or less, or no shrinkage when immersed in water at 65° C. for 10 seconds. In certain embodiments, the shrink films have shrinkage in the machine direction of from −15% to 5%, −10% to 4%, −10% to 3%, or −10% to 2.5%, or −10% to 2%, or −9% to 4%, or −8% to 4% or −7% to 4%, or −7% to 2.5%, or −7% to 2%, or 0 to 2%, or no shrinkage, when immersed in water at 65° C. for 10 seconds. Negative machine direction shrinkage percentages here indicate machine direction growth. Positive machine direction shrinkages indicate shrinkage in the machine direction.

In certain embodiments, the shrink films have shrinkage in the main shrinkage direction of from 50% or greater, or 60% or greater, or 70% or greater, when immersed in water at 95° C. for 10 seconds.

In certain embodiments, the shrink films have shrinkage in the main shrinkage direction in the amount of 50 to 80% and shrinkage in the machine direction of 4% or less, or from −15% to 5%, when immersed in water at 95° for 10 seconds.

In one embodiment, the polyester compositions of this disclosure are made into films using any method known in the art to produce films from polyesters, for example, solution casting, extrusion, compression molding, or calendering. The as-extruded (or as-formed) film is then oriented in one or more directions (e.g., monoaxially and/or biaxially oriented film). This orientation of the films can be performed by any method known in the art using standard orientation conditions. For example, the monoaxially oriented films of the present disclosure can be made from films having a thickness of about 100 to 400 microns, such as, extruded, cast or calendered films, which can be stretched at a ratio of 6.5:1 to 3:1 at a temperature of from the Tg of the film to the Tg+55° C., and which can be stretched to a thickness of 20 to 80 microns. In one embodiment, the orientation of the initial as extruded film can be performed on a tenter frame according to these orientation conditions.

In certain embodiments, the shrink films of this disclosure have no more than 40% shrinkage in the transverse direction per 5° C. temperature increase increment.

In certain embodiments, the shrink films can have an onset of shrinkage temperature of from about 55 to about 80° C., or about 55 to about 75° C., or 55 to about 70° C. “Onset of shrinkage temperature” is the temperature at which onset of shrinking occurs.

In certain embodiments, the shrink films can have an onset of shrinkage temperature of between 55° C. and 70° C.

In certain embodiments, the shrink films can have a break strain percentage greater than 100% at a stretching speed of 300 mm/minute in the direction orthogonal to the main shrinkage direction according to ASTM Method D882.

In certain embodiments, the shrinkable films can have a break strain percentage of greater than 100% at pull rates of 300 mm/minute, or 100 to 300%, or 100 to 500%, or 100 to 800%, in the machine direction according to ASTM Method D882 after ageing after ageing the film at 40° C. for at least 3 weeks.

In certain embodiments, the shrink films can have a break strain percentage of greater than 300% at a stretching speed of 300 mm/minute in the direction orthogonal to the main shrinkage direction according to ASTM Method D882.

In certain embodiments, the shrink films can have a tensile stress at break (break stress) of from 20 to 400 MPa; or 40 to 260 MPa; or 42 to 260 MPa as measured according to ASTM Method D882.

In certain embodiments, the shrink films can have a shrink force of from 4 to 18 MPa, or from 4 to 15 MPa, as measured by ISO Method 14616 depending on the stretching conditions and the end-use application desired. For example, certain labels made for plastic bottles can have an MPa of from 4 to 8 and certain labels made for glass bottles can have a shrink force of from 10 to 14 MPa as measured by ISO Method 14616 using a Shrink Force Tester made by LabThink at 80° C.

In one embodiment, the polyesters can be formed by reacting the monomers by known methods for making polyesters in what is typically referred to as reactor grade polyesters.

Reinforcing materials can be added to the polyester compositions useful in this disclosure. The reinforcing materials may include, but are not limited to, carbon filaments, silicates, mica, clay, talc, titanium dioxide, Wollastonite, glass flakes, glass beads and fibers, and polymeric fibers and combinations thereof. In one embodiment, the reinforcing materials include glass, such as, fibrous glass filaments, mixtures of glass and talc, glass and mica, and glass and polymeric fibers.

Molded articles can also be manufactured from any of the polyesters disclosed herein which may or may not consist of or contain shrink films and are included within the scope of the present disclosure.

Generally, the shrink films of the present disclosure may contain from 0.01 to 10 weight percent of a polyester plasticizer, when present. In this regard, useful polyester plasticizers can be those described in U.S. Pat. No. 10,329,395, incorporated herein by reference. In general, such polyester plasticizers are characterized by comprising (i) a polyol component comprising residues of a polyol having 2 to 8 carbon atoms, and (ii) a diacid component comprising residues of a dicarboxylic acid having 4 to 12 carbon atoms. In one embodiment, the shrink films can contain from 0.1 to 5 weight percent of the polyester plasticizer. Generally, the shrink films can contain from 90 to 99.99 weight percent of the copolyester. In certain embodiments, the shrink films can contain from 95 to 99.9 weight percent of the copolyester.

In one embodiment, when having a pre-oriented thickness of about 100 to 400 microns and then oriented on a tenter frame at from a ratio of 6.5:1 to 3:1 at a temperature of from Tg to Tg+55° C. to a thickness of from about 20 to about 80 microns, the shrink films of the present disclosure can have one or more of the following properties:
A. TD shrinkage @60° C.<2%;
B. TD shrinkage @65° C. between 2 and 30%;
C. TD shrinkage @95° C.>70%;
D. Shrink rate<4%/deg C. between 65 and 80° C.;
E. Shrink force<10 MPa; or <8 MPa; or <7 MPa
F. Tg<80° C.;
G. a break strain percentage of greater than 100% at pull rates of 300 mm/minute, or 100 to 300%, or 100 to 500%, or 100 to 800%, in the transverse direction or in the machine direction or in both directions according to ASTM Method D882;
H. a break strain percentage of greater than 100% at pull rates of 300 mm/minute, or 100 to 300%, or 100 to 500%, or 100 to 800%, in the machine direction according to ASTM Method D882 after ageing after ageing the film at 40° C. for at least 3 weeks

Any combination of these properties or all of these properties can be present in the shrink films of this disclosure. The shrink films of the present disclosure can have a combination of two or more of the above described shrink film properties. The shrink films of the present disclosure can have a combination of three or more of the above described shrink film properties. The shrink films of the present disclosure can have a combination of one or more of the above described shrink film properties. In certain embodiments, properties (A)-(H) are present. In certain embodiments, properties (A)-(B) are present. In certain embodiments, properties (A)-(C) are present, etc.

The shrinkage percentages herein are based on initial pre-shrunk films having a thickness of about 20 to 80 microns that have been oriented at a ratio of from 6.5:1 to 3:1 at a temperature of Tg to Tg+55° C. on a tenter frame, for example, at a ratio of 5:1 at a temperature from 70° C. to 85° C. In one embodiment, the shrinkage properties of the oriented films used to make the shrink films of this disclosure were not adjusted by annealing the films at a temperature higher than the temperature in which it was oriented. In another embodiment, the film properties are adjusted by annealing, by heat treatment before or after stretching.

The shape of the films useful in making the oriented films or shrink films of the present disclosure is not restricted in any way. For example, it may be a flat film or a film that has been formed into a tube. In order to produce the shrink films useful in the present disclosure, the polyester is first formed into a flat film and then is “uniaxially stretched”, meaning the polyester film is oriented in one direction. The films could also be “biaxially oriented,” meaning the polyester films are oriented in two different directions; for example, the films are stretched in both the machine direction and a direction different from the machine direction. Typically, but not always, the two directions are substantially perpendicular. For example, in one embodiment, the two directions are in the longitudinal or machine direction (“MD”) of the film (the direction in which the film is produced on a film-making machine) and the transverse direction (“TD”) of the film (the direction perpendicular to the MD of the film, the main shrinkage direction). Biaxially oriented films may be sequentially oriented, simultaneously oriented, or oriented by some combination of simultaneous and sequential stretching.

The films may be oriented by any usual method, such as the roll stretching method, the long-gap stretching method, the tenter-stretching method, and the tubular stretching method. With use of any of these methods, it is possible to conduct biaxial stretching in succession, simultaneous biaxial stretching, uni-axial stretching, or a combination of these. With the biaxial stretching mentioned above, stretching in the machine direction and transverse direction may be done at the same time. Also, the stretching may be done first in one direction and then in the other direction to result in effective biaxial stretching. In one embodiment, stretching of the films is done by preliminarily heating the films at a temperature which is from their Tg to 55° C. above their glass transition temperature (Tg). In one embodiment, the films can be preliminarily heated from Tg to 30° C. above their Tg. In one embodiment, the stretch rate is from 0.5 to 20 inches (1.27 to 50.8 cm) per second. Next, the films can be oriented, for example, in either the machine direction, the transverse direction, or both directions from 2 to 6 times the original measurements. In one embodiment, the films can be oriented as a single film layer or can be coextruded with another polyester such as PET (polyethylene terephthalate) as a multilayer film and then oriented.

In another aspect, the present disclosure provides an article of manufacture or a shaped article comprising the shrink films of any of the shrink film embodiments as set forth herein. In another embodiment, this disclosure provides an article of manufacture or a shaped article comprising the oriented films of any of the oriented film embodiments of this disclosure.

In certain embodiments, the present disclosure provides but is not limited to shrink films applied to containers, plastic bottles, glass bottles, packaging, batteries, hot fill containers, and/or industrial articles or other applications. In one embodiment, the present disclosure includes but is not limited to shrinkable films applied to containers, packaging, plastic bottles, glass bottles, photo substrates such as paper, batteries, hot fill containers, and/or industrial articles or other applications.

In certain embodiments, the shrink films of this disclosure can be formed into a label or sleeve. The label or sleeve can then be applied to an article of manufacture, such as, the wall of a container, battery, or onto a sheet or film. Accordingly, in another aspect, this disclosure provides an article of manufacture, a shaped article, a container, a plastic bottle, a cup, a glass bottle, packaging, a battery, a hot fill container, or an industrial article, having applied thereto a label or sleeve, wherein said label or sleeve is comprised of the shrink film of this disclosure as set forth herein in various embodiments. For example, the shrink films of the present disclosure can be used in many packaging applications where the shaped article exhibits properties, such as, good printability, high opacity, higher shrink force, good texture, and good stiffness.

Accordingly, the compositions of the present disclosure thus provide a combination of improved shrink properties as well as improved toughness, and thus are expected to offer new commercial options, including but not limited to, shrink films applied to containers, plastic bottles, glass bottles, packaging, batteries, hot fill containers, and/or industrial articles or other applications.

As set forth in the Experimental Section below, in the synthesis of resins used to make Comparative Examples 1˜4 and Examples 1 through 21, monomers were polymerized to high conversion to produce high molecular weight copolyesters characterized by an inherent viscosity (I.V.) in the range of 0.5-0.9 dL/g. The inherent viscosity was measured in a 60/40 parts by weight solution of phenol/tetrachloroethane at 250° C. and at a concentration of about 0.25 g of polymer in 50 mL of said solvent, at least 0.3 dL/g is required for minimal polymer physical properties.

The Tg of the polyesters in one embodiment was about 50° C. to about 80° C. In another embodiment, the Tg of the polyesters was about 58° C. to about 75° C.

The processes known for preparing polyesters were for these examples and involve an ester-interchange or esterification stage followed by a polycondensation stage. The polyester synthesis was performed as a melt phase process in the absence of organic solvents. The ester-interchange or esterification was conducted under an inert atmosphere at a temperature of about 150° C. to about 280° C. for about 0.5 to about 8 hours, or from about 180° C. to about 240° C. for about 1 to about 4 hours. The monomers (diacids or diols) vary in reactivity, depending on processing conditions, but glycol-functional monomers are commonly used in molar excesses of 1.05 to 3 moles per total moles of acid functional monomers. The polycondensation stage was performed under reduced pressure at a temperature of about 220° C. to about 350° C., or about 240° C. to about 300° C., or about 250° C. to about 290° C. for about 0.1 to about 6 hours, or from about 0.5 to about 3 hours. The reactions during both stages were facilitated by the selection of catalysts known by those skilled in the art, including but not limited to alkyl and alkoxy titanium compounds, alkali metal hydroxides and alkoxides, organotin compounds, germanium oxide, organogermanium compounds, aluminum compounds, manganese salts, zinc salts, rare earth compounds, antimony oxide, and so forth. Phosphorous compounds were used as stabilizers to control color and reactivity of residual catalysts. Typical examples are phosphoric acid, phosphonic acid, and phosphate esters, such as Merpol™ A, a product of Stepan Chemical Company.

Film fabrication was accomplished by known means to convert resin samples to films. For these small, lab-scale samples, lab-scale pressing and stretching methods were utilized. Polymer pellets were melted at a temperature of 220° C. to 290° C. or from 240° C. to 260° C. and shaped into a film of desired dimensions. For larger samples, the copolyesters were extruded using single or twin-screw extruders into film at temperatures between about 220° and 290° C. The resulting films (made using extrusion process) were stretched 2 to 6 times the original dimensions in the direction orthogonal to the extruded or machine direction at a temperature from the Tg of the resin to the Tg+55° C. For the films made using the lab-scale process they may lack a true machine direction, therefore, the samples were stretched 2 to 6 times the original dimensions in either direction at a temperature from the Tg of the resin to the Tg+55° C. In both cases, they were stretched in one direction by about 3-5 times more than the orthogonal direction at a temperature from the Tg of the resin to the Tg+55° C. The thickness of the heat-shrinkable polyester films prepared in accordance with the present examples were from 20 μm to 80 μm, or 30 μm to 50 μm.

The present disclosure can be further illustrated by the following examples of certain embodiments thereof, although it will be understood that these examples are included merely for purposes of illustration and are not intended to limit the scope of this disclosure unless otherwise specifically indicated.

### Experimental Section

### Terephthalic Acid/Ethylene Glycol (TPA/EG) Oligomer Synthesis

TPA/EG oligomers were made by feeding a single continuous stirred tank reactor (CSTR) a slurry of TPA (1.73 wt %), EG (98 mole %), and DEG (2 mole %) continuously using a 1.44 feed mole ratio at a rate of 10-23 g/min. The CSTR reactor level was kept constant at a reaction temperature of 260° C. via continuous removal of the TPA/EG oligomer product and separation/removal of the water of reaction via distillation under pressure (30 psig). TPA/EG oligomer batches were then combined to create a starting material to make new compositions.

### Copolyester Synthesis

Polymerizations were conducted with Titanium (Ti) catalyst. Depending on the composition, the synthesis was either started with TPA/EG oligomer (TPA-based) or dimethylterephthalate (DMT). After set-up of the polymerization, all reactions were performed on computer automated polymer rigs equipped with Camille Tg™ software. The Camille-recipe is shown in Table 1. On the left is the Camille recipe starting from TPA/EG oligomer, and on the right is the Camille recipe starting from DMT. For example 8, making this composition involved synthesis from TPA/EG oligomer and is described as follows: TPA/EG oligomer (100 g, 0.4 mol), 2-methyl-1,3-propanediol (MPDiol, 13.12 g, 0.15 mol), diethylene glycol (DEG, 4.5 g, 0.04 mol) and 0.33 wt % Ti solution (0.5 g) were charged into a 500 mL round bottom flask. The reaction vessel was then equipped with a nitrogen inlet, stainless steel stirrer. The sidearm was attached to a condenser that was connected to a vacuum flask. Phosphorous (P) solution (0.33 g) was added to the reaction bottle through the side arm at stage 4.

The synthesis from DMT is as follows. To make a copolyester than contains 20 mole % CHDA, 80 mole % DMT, 15 mole % neopentyl glycol (NPG), and 85 mole % EG, DMT (69.98 g, 0.36 mol), cyclohexanediacid (CHDA, 8.24 g, 0.04 mol), EG (29.24 g, 0.47 mol), NPG (14.85 g, 0.14 mol) and 0.33 wt % Ti solution (0.6 g) were charged into a 500 mL bottom flask. Using the sample reaction set-up, the Camille recipe (Table 1) for polymerization was loaded. The polymer composition and IV were analyzed.

TABLE 1
Camille recipe for resin synthesis (left table recipe is for resins made
from an oligomer and right table is for resins made from DMT).

| | Time | Temp | Pressure | Stir |
|---|---|---|---|---|
| Stage No. | (min) | (° C.) | (psi) | (rpm) |
| 1 | 0.1 | 265 | 730 | 0 |
| 2 | 8 | 265 | 730 | 125 |
| 3 | 60 | 265 | 730 | 150 |
| 4 | 2 | 265 | 730 | 150 |
| (P addition) | | | | |
| 5 | 5 | 265 | 130 | 150 |
| 6 | 40 | 265 | 130 | 150 |
| 7 | 8 | 275 | 4 | 125 |
| 8 | 42 | 275 | 4 | 75 |
| 9 | 5 | 275 | 0.6 | 75 |
| 10 | 80-120 min | 275 | 0.6 | 75 |
| | (depends) | | | |
| 11 | 2 | 275 | 730 | 0 |
| 1 | 0.1 | 205 | 730 | 0 |
| 2 | 8 | 200 | 730 | 125 |
| 3 | 60 | 200 | 730 | 150 |
| 4 | 5 | 210 | 730 | 150 |
| 5 | 90 | 210 | 730 | 150 |
| 6 | 2 | 210 | 730 | 150 |
| (P addition) | | | | |
| 7 | 5 | 265 | 130 | 125 |
| 8 | 40 | 265 | 130 | 125 |
| 9 | 8 | 275 | 4 | 125 |
| 10 | 40 | 275 | 4 | 125 |
| 11 | 5 | 280 | 0.5 | 75 |
| 12 | 90 | 280 | 0.5 | 75 |
| 13 | 2 | 21 | 730 | 0 |

### Pressed Film Forming Procedure

Pressed films were produced for some examples. The pressed films were produced from polymer pellets using a heated, manual press. Polymer pellets were dried overnight at 55° C. in a vacuum oven and subsequently pressed into 10 mil films according to the following procedure:
1. Heat manual press to 250° C.;
2. Weigh out ˜ 8 g of polymer pellets and place in the center of a 6″ by 6″ by 10 mil shim; the shim was assembled with the polymer according to the following configuration in the manual press: press plate, Kapton film, shim and polymer, Kapton film, press plate;
3. The preceding configuration was placed between the platens of the manual press and the polymer was melted under nominal pressures for approximately 2 minutes;
4. Increase the pressure to 12,000 psi and maintain pressure for approximately 45 seconds;
5. Rapidly release pressure to 0 psi and then immediately increase the pressure to 13,000 psi; Rapidly release pressure to 0 psi and then immediately increase pressure to 14,000 psi; Repeat these steps such that the pressure is continuously released to 0 psi and subsequently increased in increments of 1,000 psi until a final pressure of 16,000 psi was achieved;
6. Hold pressure at 16,000 psi for approximately 45 seconds; then release pressure to 0 psi and remove polymer from press;
7. Cut resultant polymer film out of the shim;
8. Repeat film pressing as necessary.

Pressed films were cut into 181 mm by 181 mm squares and stretched on a Bruckner Karo 4 tenter frame to a final thickness of 50 microns with a 10-second soak time and at a temperature 15° C. above Tg (i.e., 80° C.). A target stretch ratio of 5:1 (TD:MD) was achieved with a stretch rate of 100 mm/min.

### Extruded Film Forming Procedure

Extruded films were produced for some examples. In the extruded film process, the resin samples were dried in a desiccant drier at 60° C. for 4-6 h. Films with a thickness of 10 mils (250 microns) were then extruded using a 1.0″ Killion Single Screw extruder equipped with an A-B-A, 3-layer die at 220° C.-300° C., or from 240° C.-260° C. to obtain a multilayer unstretched film. For monolayer films, films with a thickness of 10 mils (250 microns) were extruded using a 1.0″ Killion Single Screw extruder equipped with single layer die at 220° C.-300° C., or from 240° C.-260° C. to obtain an unstretched film

Once extruded, the unstretched films were cut and stretched on a Bruckner Karo 4 tenter frame to a final thickness of 50 microns. The films were stretched at a 5:1 ratio, with a stretch rate of 100%/see, and a stretch temperature 5-15 degrees Celsius above the Tg of the extruded film. The stretched film was evaluated for various film properties, including glass transition temperature (Tg), shrinkage as a function of temperature (shrink curve), shrink force, shrink force as a function of ageing time, machine direction (unstretched direction) strain at break initially and as a function of ageing time.

The heat-shrinkable polyester films produced for some examples were prepared by a method comprising the following steps of (a) melting and extruding the resin either as a monolayer film or with certain layer structures to obtain an unstretched A|B|A multilayer film; (b) stretching the unstretched multilayer film in the one direction at temperatures between its Tg and Tg+55° C.; (c) evaluating various film properties (including glass transition temperature (Tg), shrinkage as a function of temperature (shrink curve), tensile test and shrink force (SF)) and (d) monitoring film MD break strain initially after stretching and then after ageing the multilayer film at 40° C. for certain amounts of time.

### Multilayer Structure/Composition Ranges

The multilayer film comprising three layers—ABA structure—as shown in Scheme 1. The first and second skin layer (layer A) containing resin 1 or resin 2 (Table 1) are both adjacent to a core layer (layer B). The skin layers can be made from a single resin or can be made with a polyester blend with polyester ratios in the skin layers by weight ranging from 100/0 to 0/100. The compositions of copolyesters in the first and second skin layers (layer A) comprising residues of:
1) A diacid component containing at least 70 mol % terephthalic acid residues
2) A diol component containing (i) about 50 to about 85 mol % EG residues
   (ii) about 0-35 mol % CHDM residues, (iii) 0-30 mol % NPG residues and
   (iv) 0.1-15 mol % DEG residues with the final polymer containing substantially equal molar proportions of acid equivalents (100 mole %) and diol equivalents (100 mole %).

The core layer (layer B) arranged between the first and second skin layer (layer A) comprised of a copolyester containing MPDiol monomer. The compositions of copolyesters in the core layer (layer B) comprising residues of:
1) A diacid component containing at least 70 mol % terephthalic acid residues
2) A diol component containing (i) about 50 to about 85 mol % EG residues (ii) about 1-35 mol % MPDiol residues, (iii) 0-25 mol % CHDM residues, or 5-15 mol % CHDM residues and (iv) 0.1-15 mol % DEG residues, or 5-12 mol % DEG residues.
   with the final polymer containing substantially equal molar proportions of acid equivalents (100 mole %) and diol equivalents (100 mole %) for a total of 200 mole % for all reactants.

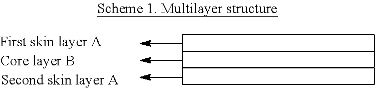

TABLE 1
Resin used in the multilayer film

| | | | | | | | Glass |
|---|---|---|---|---|---|---|---|
| | Acids | Glycols | | | | | transition |
| | TPA | EG | MPDiol | CHDM | NPG | DEG | temperature |
| | (mol % | (mol %) | (mol %) | (mol %) | (mol %) | (mol %) | (Tg, ° C.) |
| Resin 1 | 100 | 65 | | 23 | | 12 | 70 |
| Resin 2 | 100 | 82 | | 3 | 11 | 4 | 75 |
| Resin 3 | 100 | 65 | 15 | 10 | | 10 | 66 |
| Resin 4 | 100 | 68 | 23 | | | 9 | 63 |

TABLE 2
Multilayer structures

| | | Example 12 | | Example 13 | | Example 14 | | Example 15 | | Example 16 | | Example 17 | |
|---|---|---|---|---|---|---|---|---|---|---|---|---|---|
| | | Skin | Core | Skin | Core | Skin | Core | Skin | Core | Skin | Core | Skin | Core |
| | | layer A | layer B | layer A | layer B | layer A | layer B | layer A | layer B | layer A | layer B | layer A | layer B |
| A\|B\|A layer | Resin 1 | 100 | | | | 100 | | 70 | | 50 | | 30 | |
| composition | | | | | | | | | | | | | |
| (wt %) | Resin 2 | | | 100 | | | | 30 | | 50 | | 70 | |
| A layer | | | | | | | | | | | | | |
| thickness: 2 | Resin 3 | | 100 | | 100 | | | | | | | | |
| mil | | | | | | | | | | | | | |
| B layer | Resin 4 | | | | | | 100 | | 100 | | 100 | | 100 |
| thickness: 6 | | | | | | | | | | | | | |
| mil | | | | | | | | | | | | | |

| | | Example 18 | | Example 19 | | Example 20 | | Example 21 | |
|---|---|---|---|---|---|---|---|---|---|
| | | Skin | Core | Skin | Core | Skin | Core | Skin | Core |
| | | layer A | layer B | layer A | layer B | layer A | layer B | layer A | layer B |
| A\|B\|A layer | Resin 1 | 100 | | 100 | | | | | |
| composition | | | | | | | | | |
| (wt %) | Resin 2 | | | | | 100 | | 100 | |
| A layer | | | | | | | | | |
| thickness: 1 | Resin 3 | | 100 | | 100 | | 100 | | 100 |
| or 3 mil | | | | | | | | | |
| B layer | Resin 4 | | | | | | | | |
| thickness: 8 | | | | | | | | | |
| or 4 mil | | | | | | | | | |

### Film Property Ranges

For thermal properties in each layer, the first and second skin layers (layer A) have a Tg≥65° C., or have a Tg≥70° C. measured from the second scan of Differential Scanning calorimetry (DSC) at a scan rate of 20° C./min. The core layer (layer B) arranged between the first and second skin layers has a Tg≤75° C., or a Tg≤70° C.

For the film thickness in each layer, the first and second skin layers (layer A) each have thickness ranging from 1-2 mil and the core layer (layer B) has a thickness ranging from 4-6 mil prior to stretching.

The performance properties for stretched or shrinkable films of the present disclosure include (a) an onset of shrinkage temperature of 65° C. or lower. Onset shrinkage temperature is the lowest temperature at which shrinkage occurs. (b) A heat shrinkage at 65° C. between 5 and 30% when heat-treated in a water bath for 10 seconds; (c) The ultimate shrinkage in the main shrinkage direction (transverse direction, TD) of at least have 50%, or in some embodiments 70% or greater, which increases gradually with increasing temperature; (d) A shrink rate<4%/deg C. between 65 and 80° C.; (e) The final shrinkage films should also possess a shrink force less than 10 MPa measure at 80° C. or less than 8 MPa or less than 7 MPa; (f) a break strain percentage of greater than 100% at pull rates of 300 mm/minute, or 100 to 300%, or 100 to 500%, or 100 to 800%, in the transverse direction or in the machine direction or in both directions according to ASTM Method D882 (e) a break strain percentage of greater than 100% at pull rates of 300 mm/minute, or 100 to 300%, or 100 to 500%, or 100 to 800%, in the machine direction according to ASTM Method D882 after ageing after ageing the film at 40° C. for at least 3 weeks. Film preferably have an inherent viscosity (I.V.) of 0.5-0.9 dL/g, more preferred of 0.55-0.75 dL/g for good film physical property and film processability.

### EXPERIMENTAL SECTION

### Analytical Test

### 1. Inherent Viscosity (I.V.)

IV is measured in a 60/40 parts by weight solution of phenol/tetrachloroethane at 250° C. and at a concentration of about 0.5 g of polymer in 100 mL of said solvent.

### 2. Film Glass Transition Temperature (Tg)

All thermal tests for these pellets and stretched films were completed at standard differential scanning calorimetry (DSC) scans at a scan rate of 20° C./min.

### 3. Tensile Property

The film was tested for MD break strain using ASTM Method D882. The film was prepared by cutting them to 3.5″×0.5″ strips and tested at a stretching speed of 300 mm/min. MD break strain was tested after setting the film at R. T. for 0, 2, 4 and 6 weeks. Multilayer film with resin 4 as core layer was also tested at accelerated ageing condition 40° C. for comparison.

### 4. Shrink Force

Shrink force was determined using a Labthink FST-02 shrink force tester. Shrink force measurements were conducted under the same temperature conditions as the stretching temperatures used to stretch films on the Bruckner (80° C.) and held in the heating chamber for 60 seconds. The maximum shrink force value of each film was measured.

### 5. Shrinkage

Shrinkage was measured by placing a 50 mm by 50 mm square film sample in water at temperatures ranging from 60° C. to 95° C. for 10 seconds without restricting shrinkage in any direction. The percent shrinkage was then calculated by the following equation:

% shrinkage=[(50 mm-length after shrinkage)/50 mm]×100%
Shrinkage was measured in the direction orthogonal to the main shrinkage direction (machine direction, MD) and was also measured in the main shrinkage direction (transverse direction, TD).
Negative shrinkage indicated growth

### EXAMPLES

### 1. Comparative Examples—MPDiol Resin Monolayer

The composition and film properties of comparative example 1 are shown in the table below. Stretching conditions to make this film include a stretch temperature of 80° C., a stretch rate of 100% (mm/min), a stretch ratio of 5:1 (TD:MD), a 30 second soak time prior to stretching at the stretch temp.

Comparative Example 1 met some requirements but the MD Elongation at break for Comparative example 1 decreased rapidly with ageing at 40° C.

The property strain at break is also referred to as break strain and elongation at break. These terms all have the same meaning and they are used interchangeably in this disclosure.

In some embodiments, the property is referred to as MD break strain, MD strain at break, or MD elongation at break, and the MD refers to the direction in which the film is tested (MD vs TD). MD is the machine direction (the direction orthogonal to the main shrinkage direction). TD is the transverse direction (the main shrinkage direction).

TABLE 3
Composition of resins used to make films of Comparative Example 1

| Example # | | Comparative Example 1 |
|---|---|---|
| Monolayer film | | |
| IV, Inherent viscosity (dL/g) | | 0.747 |
| Tg, Glass transition temp. (° C.) | | 67 |
| Compositions | TPA (mol %) | 100 |
| | EG (mol %) | 63.1 |
| | MPDiol (mol %) | 15.1 |
| | CHDM (mol %) | 10.4 |
| | DEG (mol %) | 9.9 |
| | TEG (mole %) | 1.5 |

TABLE 4
Monolayer Film properties of Comparative Example 1

| | |
|---|---|
| Example # | Comparative Example 1 |

Monolayer film

| | Temp. | | |
|---|---|---|---|
| | (° C.) | MD | TD |
| Heat | 60 | −2 | 2 |
| shrinkage | 65 | −3 | 21 |
| (%)-no | 70 | −9 | 40 |
| ageing | 75 | −10 | 50 |
| | 80 | −11 | 61 |
| | 85 | −9 | 67 |
| | 90 | −7 | 74 |
| | 95 | −6 | 77 |

Ageing study

| | | | Aged |
|---|---|---|---|
| | | | at 40° |
| | Days | Aged at R.T | C. |
| MD | 0 | 544 | 450 |
| elongation | 1 | NM | NM |
| @break | 4 | 351 | 71 |
| | 6 | 208 | 4.4 |
| % of | 0 | 100% | 100% |
| samples | 1 | NM | NM |
| shown | 4 | 60% | 20% |
| >100% | 6 | 40% | 0% |
| break strain | | | |

TABLE 5
Composition of resins used to make films of
Comparative Examples 2-4

| | | Com- | Com- | Com- |
|---|---|---|---|---|
| | | parative | parative | parative |
| Example # | | Example 2 | Example 3 | Example 4 |
| Monolayer film | | Resin 1 | Resin Blend: | Resin 4 |
| | | | Resin | |
| | | | 1/Resin 4 | |
| | | | 50/50 | |
| IV, Inherent viscosity (dL/g) | | | | |
| Tg, Glass transition temp. | | 70 | 64.6 | 61.3 |
| (° C.) | | | | |
| Compositions | TPA (mol | 100 | 100 | 100 |
| | %) | | | |
| | EG (mol | 64 | 64 | 65.3 |
| | %) | | | |
| | MPDiol | 0 | 13.2 | 24.8 |
| | (mol %) | | | |
| | CHDM | 23.1 | 11.3 | 0 |
| | (mol %) | | | |
| | DEG (mol | 11.9 | 0.6 | 9.9 |
| | %) | | | |
| | TEG | 0.9 | 0.9 | 0 |
| | (mole %) | | | |

### Table 6: Monolayer Film Properties of Camparitive Examples 2-4

Comparative Examples 2 and 3 did not have TD shrinkage greater than 2% at 65° C. The MD elongation at break for Comparative examples 3 and 4 decreased rapidly with ageing at 40° C.

TABLE 6
Monolayer film properties of Comparative Examples 2-4

| | | Example # | | | | | |
|---|---|---|---|---|---|---|---|
| | | Comparative | | Comparative | | Comparative | |
| | | Example 2 | | Example 3 | | Example 4 | |
| Monolayer film | | Resin 1 | | Resin 1/Resin 4 | | Resin 4 | |
| | | | | 50/50 | | | |
| | Temp. | MD | TD | MD | TD | MD | TD |
| | (° C.) | | | | | | |
| Heat | 60 | 0 | 0 | 0 | 0 | 0 | 2 |
| shrinkage | 65 | 1 | 1 | 0 | 6 | −2 | 22 |
| (%) - no | 70 | 4 | 13 | −2 | 28 | −6 | 42 |
| ageing | 75 | −2 | 38 | −6 | 44 | −8 | 48 |
| | 80 | −6 | 56 | −8 | 54 | −14 | 59 |
| | 85 | −6 | 72 | −6 | 66 | −8 | 62 |
| | 90 | −3 | 77 | −5 | 72 | −10 | 66 |
| | 95 | 0 | 79 | −2 | 76 | −8 | 72 |
| Shrink | 80° C. | 6.1 | | 4.3 | | 2.0 | |
| Force | | | | | | | |
| (MPa) | | | | | | | |

Ageing study

| | Weeks | Aged at 40° C. | Aged at 40° C. | Aged at 40° C. |
|---|---|---|---|---|
| MD | 0 | 537 | 64 | 3 |
| elongation | 1 | 257 | 2 | 2 |
| @break | 4 | 423 | 4 | 3 |
| | 6 | 345 | NM | |

| | Weeks | Aged at 40° C. | Aged at 40° C. | Aged at 40° C. |
|---|---|---|---|---|
| % of | 0 | 100% | 20% | 0% |
| samples | | | | |

| | | | | |
|---|---|---|---|---|
| shown >100% | 4 | 80% | 0% | 0% |
| break strain | 6 | 40% | 0% | 0% |

### Table 7: Composition of Resins Used to Make Films of Examples 1-4

The composition and film properties of example 1-4 are shown in the table below. Stretching conditions to make this film include a stretch temperature of 80° C., a stretch rate of 50% (mm/min), a stretch ratio of 5:1 (TD:MD), a 30 second soak time prior to stretching at the stretch temp.

TABLE 7
Composition of resins used to make films of Examples 1-4

| | | Exam- | Exam- | Exam- | Exam- |
|---|---|---|---|---|---|
| | | ple | ple | ple | ple |
| Example # | | 1 | 2 | 3 | 4 |
| Monolayer film | | target | MPDiol | MPDiol | MPDiol |
| | | comp | resin | resin | resin |
| IV, Inherent viscosity (dL/g) | | | 0.723 | 0.744 | 0.731 |
| Tg, Glass transition temp. | | | 70.1 | 69.1 | 65.8 |
| (° C.) | | | | | |
| Compositions | TPA (mol | 100 | 100 | 100 | 100 |
| | %) | | | | |
| | EG (mol | 67.2 | 72.6 | 81.7 | 65.3 |
| | %) | | | | |
| | MPDiol | 12.6 | 10.5 | 14.5 | 14.6 |
| | (mol %) | | | | |
| | CHDM | 11.8 | 9.9 | 12 | 10.1 |
| | (mol %) | | | | |
| | DEG | 8.4 | 7 | 6.3 | 10 |
| | (mol %) | | | | |
| | TEG | 0 | 0 | 0 | 0 |
| | (mole %) | | | | |

### Table 8: Monolayer Film Properties of Examples 1-4

Examples 1-4 describes compositions that meet all the film performance requirements.

TABLE 8
Monolayer Film properties of Examples 1-4

| Example # | | 1 | | 2 | | 3 | | 4 | |
|---|---|---|---|---|---|---|---|---|---|
| Monolayer film | | target comp | | MPDiol resin | | MPDiol resin | | MPDiol resin | |
| | Temp. | MD | TD | MD | TD | MD | TD | MD | TD |
| | (° C.) | | | | | | | | |
| Heat | 60 | | | 0 | 2 | 0 | 1 | | |
| shrinkage | 65 | 0 | 20 | 2 | 10 | 1 | 7 | 0 | 19 |
| (%) - no | 70 | −6 | 54 | 2 | 18 | −1 | 25 | | |
| ageing | 75 | −5 | 64 | −2 | 36 | −6 | 51 | −5 | 58 |
| | 80 | −3 | 74 | −10 | 58 | −6 | 68 | | |
| | 85 | −2 | 77 | −8 | 62 | −6 | 72 | −5 | 74 |
| | 90 | | | −6 | 72 | −5 | 76 | | |
| | 95 | 0 | 79 | −10 | 78 | −4 | 78 | −1 | 79 |
| Shrink | 80 C | 5.9 | | 7.3 | | 6.6 | | 6.2 | |
| Force | | | | | | | | | |
| (MPa) | | | | | | | | | |
| Ageing study | | | | | | | | | |
| | Weeks | Aged at 40° C. | | Aged at 40° C. | | Aged at 40° C. | | Aged at 40° C. | |
| MD | 0 | 539 | | 562 | | 568 | | 118 | |
| elongation | 1 | 554 | | 192 | | | | | |
| @break | 2 | 439 | | | | | | | |
| | 3 | | | 267 | | | | | |
| | 4 | | | | | | | | |

| | |
|---|---|
| 6 | 591 |

| % of | 0 | 100% | 100% | 100% | 40% |
|---|---|---|---|---|---|
| samples | 1 | 100% | 60% | | |
| shown > 100% | 2 | 100% | | | |

| | | |
|---|---|---|
| break strain | 3 | 100% |
| | 4 | |
| | 6 | 100% |

### Table 9: Composition of Resins Used to Make Films of Examples 5-7

### Examples 5-7

The composition and film properties of example 5-7 are shown in the table below. Stretching conditions to make this film include a stretch temperature of 80° C., a stretch rate of 50% (mm/min), a stretch ratio of 5:1 (TD:MD), a 30 second soak time prior to stretching at the stretch temp.

TABLE 9
Composition of resins used to make films of Examples 5-7

| Example # | | Example 5 | Example 6 | Example 7 |
|---|---|---|---|---|
| Monolayer film | | | | |
| IV, Inherent viscosity | | 0.725 | 0.671 | 0.757 |
| (dL/g) | | | | |
| Tg, Glass transition | | 64.8 | 64.3 | 70 |
| temp. (° C.) | | | | |
| Compositions | TPA | 100 | 100 | 100 |
| | (mol %) | | | |
| | EG (mol | 63.6 | 66.5 | 67.2 |
| | %) | | | |
| | MPDiol | 0 | 0 | 0 |
| | (mol %) | | | |
| | CHDM | 17.7 | 0 | 0 |
| | (mol %) | | | |
| | NPG | | 17.3 | 23 |
| | DEG | 17.8 | 16.3 | 9.8 |
| | (mol %) | | | |
| | TEG | 0.9 | 0 | 0 |
| | (mole | | | |
| | %) | | | |

### Table 10: Film Properties of Examples 5-7

The MD elongation at break for examples 5 thru 7 decreased rapidly with ageing at 40° C.

TABLE 10
Film properties of Examples 5-7

| Example # | | 5 | | 6 | | | 7 |
|---|---|---|---|---|---|---|---|
| Monolayer film | | | | | | | |
| | Temp. | MD | TD | MD | TD | MD | TD |
| | (° C.) | | | | | | |
| Heat | 60 | 0 | 2 | 0 | 1 | 0 | 3 |
| shrinkage | 65 | 2 | 16 | −2 | 6 | −12 | 43 |
| (%) - no | 70 | −4 | 41 | −8 | 35 | −17 | 58 |
| ageing | 75 | −6 | 58 | −12 | 52 | −18 | 62 |
| | 80 | −8 | 66 | −18 | 66 | −16 | 69 |
| | 85 | −7 | 72 | −18 | 74 | 2 | 74 |
| | 90 | −4 | 76 | −10 | 76 | −8 | 76 |
| | 95 | −1 | 78 | −4 | 80 | −4 | 79 |
| Shrink | 80 C | 5.5 | | 6.8 | | 4.7 | |
| Force | | | | | | | |
| (MPa) | | | | | | | |
| Ageing | | | | | | | |
| study | | | | | | | |
| | Weeks | Aged at | | Aged at | | Aged at | |
| | | 40° C. | | 40° C. | | 40° C. | |
| MD | 0 | 419 | | 251 | | 105 | |
| elongation | 1 | 117 | | 26 | | 1.1 | |
| @break | 2 | | | | | | |
| | 3 | 2.2 | | | | | |
| | 4 | | | | | | |
| | 6 | | | | | | |
| % of samples | 0 | 80% | | 80% | | 40% | |
| shown > 100% | 1 | 80% | | 0% | | 0% | |
| break strain | 2 | | | | | | |
| | 4 | 0% | | | | | |
| | 6 | | | | | | |

### Table 11: Composition of Resin Blends Used to Make Films of Examples 8-11

### Examples 8-11

The composition and film properties of example 8-11 are shown in the table below. Stretching conditions to make this film include a stretch temperature of 80° C., a stretch rate of 100% (mm/min), a stretch ratio of 5:1 (TD:MD), a 30 second soak time prior to stretching at the stretch temp.

TABLE 11
Composition of resin blends used to make films of Examples 8-11

| | | Example | Example | Example | Example |
|---|---|---|---|---|---|
| Example # | | 8 | 9 | 10 | 11 |
| Monolayer film | | Resin | Resin | Resin | Resin |
| | | 1/Resin 4 | 1/Resin | 1/Resin | 1/Resin 4 |
| | | 50-50 | 4 60-40 | 4 70-30 | 80-20 |
| IV, Inherent viscosity | | | | | |
| (dL/g) | | | | | |
| Tg, Glass transition | | 65.3 | 66.2 | 66.7 | 67.4 |
| temp. (° C.) | | | | | |
| Compositions | TPA (mol | 100 | 100 | 100 | 100 |
| | %) | | | | |
| | EG (mol | 64.07 | 64.52 | 64.6 | 64.39 |
| | %) | | | | |
| | MPDiol | 12.73 | 10.36 | 7.79 | 5.33 |
| | (mol %) | | | | |
| | CHDM | 11.75 | 13.67 | 16.04 | 18.35 |
| | (mol %) | | | | |
| | NPG | 0 | 0 | 0 | 0 |
| | DEG | 10.29 | 10.25 | 10.33 | 10.5 |
| | (mol %) | | | | |
| | TEG | 1.16 | 1.21 | 1.24 | 1.43 |
| | (mole %) | | | | |

### Table 12: Film Properties of Examples 8-11

The MD elongation at break for examples 8 thru 11 decreased rapidly with ageing at 40° C.

TABLE 12
Film properties of Examples 8-11

| Example # | | 8 | | 9 | | 10 | | 11 | |
|---|---|---|---|---|---|---|---|---|---|
| Monolayer film | | | | | | | | | |
| | Temp. | MD | TD | MD | TD | MD | TD | MD | TD |
| | (° C.) | | | | | | | | |
| Heat | 60 | 1 | 2 | −1 | 2 | −1 | 1 | 0 | 2 |
| shrinkage | 65 | −8 | 33 | −4 | 26 | −3 | 22 | −2 | 16 |
| (%) - no | 70 | −11 | 46 | −12 | 46 | −11 | 47 | −6 | 41 |
| ageing | 75 | −14 | 59 | −13 | 58 | −13 | 60 | −12 | 52 |
| | 80 | −14 | 65 | −12 | 66 | −11 | 65 | −20 | 66 |
| | 85 | −11 | 71 | −12 | 70 | −11 | 73 | −12 | 71 |
| | 90 | −8 | 74 | −9 | 75 | −10 | 76 | −12 | 77 |
| | 95 | −7 | 77 | −7 | 74 | −7 | 78 | −16 | 78 |
| Shrink | 80 C. | 3.4 | | 5.9 | | 5.2 | | 5.4 | |
| Force | | | | | | | | | |
| (MPa) | | | | | | | | | |
| Ageing | | | | | | | | | |
| study | | | | | | | | | |
| MD | Weeks | Aged at | | Aged at | | Aged at | | Aged at | |
| elongation | | 40° C. | | 40° C. | | 40° C. | | 40° C. | |
| @break | 0 | 58 | | 139 | | 196 | | 685 | |
| | 1 | 5 | | 37 | | 5 | | 8 | |
| | 2 | | | | | | | | |
| | 4 | 5 | | 4 | | 5 | | 4 | |
| | 6 | 4 | | 4 | | 4 | | 4 | |
| % of samples | 0 | 0% | | 20% | | 60% | | 100% | |
| shown > 100% | 1 | 0% | | 20% | | 0% | | 0% | |
| break strain | 2 | | | | | | | | |

| | | | | |
|---|---|---|---|---|
| 4 | 0% | 0% | 0% | 0% |
| 6 | 0% | 0% | 0% | 0% |

### Table 13: Total Film Composition and Film Properties for Examples 12-13

### Examples 12-13: Multilayer Films

The composition and film properties of example 12-13 are shown in the table below. Stretching conditions to make this film include a stretch temperature of 80° C., a stretch rate of 100% (mm/min), a stretch ratio of 5:1 (TD:MD), a 30 second soak time prior to stretching at the stretch temp.

Example 12 met the requirements. Example 13 did have TD shrinkage greater than 2% at 65° C.

TABLE 13
Total film composition and film properties for Examples 12-13

| | | Example 12 | | Example 13 | |
|---|---|---|---|---|---|
| | | Skin | Core | Skin | Core |
| | | layer A | layer B | layer A | layer B |
| A\|B\|A layer | Resin 1 | 100 | | | |
| composition (wt %) | Resin 2 | | | 100 | |
| | Resin 3 | | 100 | | 100 |
| | Resin 4 | | | | |
| A layer\|B layer\|A layer thickness | | 45\|135\|48 | | 44\|148\|45 | |
| (μm) | | | | | |
| IV, Inherent viscosity (dL/g) | | 0.738 | | 0.665 | |
| Tg, Glass transition temp. (° C.) | | 66 | | Tg, 1 = 66, | |
| | | | | Tg, 2 = 76 | |
| Strain-induced Tm (° C.) | | 160.98 | | 209.36 | |
| Composition | TPA (mol %) | 100 | | 100 | |
| | EG (mol %) | 63.93 | | 75.63 | |
| | TEG (mol %) | 1.85 | | 0.74 | |
| | NPG (mol %) | 0.00 | | 6.28 | |
| | MPDiol | 6.48 | | 5.52 | |
| | (mol %) | | | | |
| | CHDM | 17.33 | | 6.12 | |
| | (mol %) | | | | |
| | DEG (mol %) | 10.41 | | 5.71 | |
| | Temp. | | | | |
| | (° C.) | MD | TD | MD | TD |
| Heat shrinkage | 60.00 | 0 | 2.5 | 0 | 1 |
| (%)-no | 65.00 | −3 | 27 | 0.5 | 4 |
| ageing | 70.00 | −7 | 49 | 3.5 | 17.5 |
| | 75.00 | −9 | 58 | 0 | 39 |
| | 80.00 | −11.5 | 64.5 | −6 | 61 |
| | 85.00 | −8 | 71.5 | −2.5 | 63 |
| | 90.00 | −2.5 | 75 | −2 | 70 |
| | 95.00 | −3.5 | 77.5 | 0.5 | 71 |

Ageing study

| | Weeks | Aged at R.T | Aged at R.T |
|---|---|---|---|
| MD elongation | 0 | 503 | 672 |
| @break | 2 | 445 | 604 |
| | 4 | 61 | 713 |
| | 6 | 136 | 548 |
| % of samples | 0 | 100% | 100% |
| shown >100% | 2 | 100% | 100% |
| break strain | 4 | 40% | 100% |
| | 6 | 20% | 80% |
| Shrink force | | 5.3 | |
| (MPa) | | | |

### Table 14: Total Film Composition and Film Properties for Examples 14-15

### Examples 14-15: Multilayer Films

The composition and film properties of example 14-15 are shown in the table below. Stretching conditions to make this film include a stretch temperature of 80° C., a stretch rate of 100% (mm/min), a stretch ratio of 5:1 (TD:MD), a 30 second soak time prior to stretching at the stretch temp.

The MD Elongation at break decreased rapidly for Example 14 at 40° C. Example 15 met the requirements.

TABLE 14
Total film composition and film properties for Examples 14-15

| | | Example 14 | | Example 15 | |
|---|---|---|---|---|---|
| | | Skin | Core | Skin | Core |
| | | layer A | layer B | layer A | layer B |
| A\|B\|A layer | Resin 1 | 100 | | 70 | |
| composition | Resin 2 | | | 30 | |
| (wt %) | Resin 3 | | | | |
| | Resin 4 | | 100 | | 100 |
| A layer\|B layer\|A layer thickness | | 49\|162\|42 | | 47\|130\|40 | |
| (μm) | | | | | |
| IV, Inherent viscosity (dL/g) | | 0.675 | | 0.695 | |
| Tg, Glass transition temp. (° C.) | | 65.83 | | 66.47 | |
| Strain-induced Tm (° C.) | | 159.73 | | 168.02 | |
| Composition | TPA (mol %) | 100 | | 100 | |
| | EG (mol %) | 63.97 | | 66.41 | |
| | TEG (mol %) | 1.15 | | 1.00 | |
| | NPG (mol %) | 0.00 | | 1.90 | |
| | MPDiol (mol %) | 13.43 | | 13.09 | |
| | CHDM (mol %) | 11.02 | | 8.22 | |
| | DEG (mol %) | 10.43 | | 9.38 | |
| | Temp. | MD | TD | MD | TD |
| | (° C.) | | | | |
| Heat shrinkage | 60.00 | 0 | 2 | 1 | 1 |
| (%) - no | 65.00 | 0 | 17 | 1 | 7 |
| ageing | 70.00 | −4 | 38 | 2 | 30 |
| | 75.00 | −2 | 56 | −6 | 52 |
| | 80.00 | −10 | 70 | −8 | 62 |
| | 85.00 | −6 | 74 | −8 | 72 |
| | 90.00 | −8 | 78 | −6 | 76 |
| | 95.00 | −6 | 78 | −6 | 77 |

| Example 14 | | Example 15 | |
|---|---|---|---|
| Skin | Core | Skin | Core |
| layer A | layer B | layer A | layer B |

Ageing study

| | Week | Aged at | Aged at | Aged at | Aged at |
|---|---|---|---|---|---|
| | | R.T | 40° C. | R.T | 40° C. |
| MD elongation | 0 | 564 | 564 | 609 | 609 |
| @break | 2 | 505 | 184 | 632 | 516 |
| | 4 | 519 | 3.8 | 640 | 127 |
| | 6 | 468 | 3.5 | 647 | 331 |
| % of samples | 0 | 100% | 100% | 100% | 100% |
| shown >100% | 2 | 100% | 100% | 100% | 100% |
| break strain | 4 | 100% | 0 | 100% | 40% |
| | 6 | 100% | 0 | 100% | 60% |
| Shrink force | 0 | 4.9 | 4.9 | 5.2 | 5.2 |
| (MPa) | 2 | 4.5 | 4.7 | 4.7 | 4.3 |
| | 4 | 5.2 | 4.6 | 5.9 | 5.3 |
| | 6 | 4.8 | 4.2 | 6.5 | 6.1 |
| TD heat | 2 | 40 | 3 | 29 | 2 |
| shrinkage @70° C. | 6 | 33 | 2 | 21 | 2 |
| after 6 weeks | | | | | |
| (%) | | | | | |

### Table 15: Total Film Composition and Film Properties for Examples 16-17

The composition and film properties of examples 16-17 are shown in the table below. Stretching conditions to make this film include a stretch temperature of 80° C., a stretch rate of 100% (mm/min), a stretch ratio of 5:1 (TD:MD), a 30 second soak time prior to stretching at the stretch temp.

Examples 16 and 17 did meet the requirements.

TABLE 15
Total film composition and film properties for Examples 16-17

| | | Example 16 | | Example 17 | |
|---|---|---|---|---|---|
| | | Skin | Core | Skin | Core |
| | | layer A | layer B | layer A | layer B |
| A\|B\|A layer | Resin 1 | 50 | | 30 | |
| composition | Resin 2 | 50 | | 70 | |
| (wt %) | Resin 3 | | | | |
| | Resin 4 | | 100 | | 100 |
| A layer\|B layer\|A layer thickness (mm) | | 41\|134\|40 | | 47\|125\|45 | |
| IV, Inherent viscosity (dL/g) | | 0.683 | | 0.678 | |
| Tg, Glass transition temp. (° C.) | | 66.8 | | 69.2 | |
| Strain-induced Tm (deg C.) | | 203 | | 210 | |
| Composition | TPA (mol %) | 100 | | 100 | |
| | EG (mol %) | 68.87 | | 69.82 | |
| | TEG (mol %) | 0.90 | | 0.77 | |
| | NPG (mol %) | 3.12 | | 3.77 | |
| | MPDiol (mol %) | 11.15 | | 13.07 | |
| | CHDM (mol %) | 7.46 | | 4.60 | |
| | DEG (mol %) | 8.50 | | 7.97 | |
| | Temp. | MD | TD | MD | TD |
| | (° C.) | | | | |
| Heat | 60.00 | 0 | 1 | 0 | 1 |
| shrinkage | 65.00 | 1 | 4 | 1 | 4 |
| (%) - no | 70.00 | 2 | 22 | 4 | 16 |
| ageing | 75.00 | −3 | 40 | −2 | 41 |
| | 80.00 | −8 | 61 | −6 | 58 |
| | 85.00 | −8 | 70 | −7 | 68 |
| | 90.00 | −4 | 74 | −6 | 70 |
| | 95.00 | −5 | 76 | −4 | 74 |

Ageing study

| | Week | Aged at | Aged at | Aged at | Aged at |
|---|---|---|---|---|---|
| | | R.T | 40° C. | R.T | 40° C. |
| MD | 0 | 624 | 624 | 648 | 648 |
| elongation | 2 | 644 | 478 | 495 | 441 |
| @break | 4 | 629 | 97 | 620 | 302 |
| | 6 | 661 | 112 | 685 | 118 |
| % of | 0 | 100% | 100% | 100% | 100% |
| samples | 2 | 100% | 100% | 80% | 100% |
| shown >100% | 4 | 100% | 20% | 100% | 60% |
| break strain | 6 | 100% | 40% | 100% | 20% |
| | 0 | 5.5 | 5.5 | 6.0 | 6.0 |
| | 2 | 6 | 6.4 | 6.2 | 6.0 |
| Shrink force | 4 | 5.7 | 5.3 | 5.4 | 5.5 |
| (MPa) | 6 | 6.4 | 6.2 | 7.0 | 6.3 |
| Heat shrinkage | 2 | 25 | 2 | 23 | 2 |
| @70 C. after | 6 | 18 | 2 | 10 | 2 |
| 6 weeks (%) | | | | | |

### Table 16: Total Film Composition and Film Properties for Examples 18-19

### Examples 18 and 19

The composition and film properties of examples 18-19 are shown in the table below. Stretching conditions to make this film include a stretch temperature of 80° C., a stretch rate of 100% (mm/min), a stretch ratio of 5:1 (TD:MD), a 30 second soak time prior to stretching at the stretch temp.

Examples 18 and 19 meet the requirements.

TABLE 16
Total film composition and film properties for Examples 18-19

| | | Example 18 | | | Example 19 | |
|---|---|---|---|---|---|---|
| | | Skin | Core | | Skin | Core |
| | | layer A | layer B | | layer A | layer B |
| A\|B\|A layer | Resin 1 | 100 | | | 100 | |
| composition | Resin 2 | | | | | |
| (wt %) | Resin 3 | | 100 | | | 100 |
| | Resin 4 | | | | | |
| IV, Inherent viscosity | | 0.738 | | | 0.717 | |
| (dL/g) | | | | | | |
| Tg, Glass transition temp. | | 65.98 | | | 68.04 | |
| (° C.) | | | | | | |
| Strain-induced Tm (° C.) | | 161.67 | | | 162.25 | |
| Composition | TPA | 100 | | | 100 | |
| | (mol %) | | | | | |
| | EG (mol %) | 63.67 | | | 65.95 | |
| | TEG | 1.43 | | | 0.00 | |
| | (mol %) | | | | | |
| | NPG | 0.77 | | | 0.00 | |
| | (mol %) | | | | | |
| | MPDiol | 9.77 | | | 4.37 | |
| | (mol %) | | | | | |
| | CHDM | 14.19 | | | 19.05 | |
| | (mol %) | | | | | |
| | DEG | 10.17 | | | 10.63 | |
| | (mol %) | | | | | |
| | | Temp. | MD | TD | MD | TD |
| | | (° C.) | | | | |
| Heat shrinkage | | 60.00 | 0 | 2 | 0 | 1 |
| (%) - no | | 65.00 | 1 | 12 | 1 | 5 |
| ageing | | 70.00 | −2 | 29 | 0 | 26 |
| | | 75.00 | −9 | 52 | −4 | 54 |
| | | 80.00 | −14 | 65 | −12 | 68 |
| | | 85.00 | −10 | 74 | −11 | 74 |
| | | 90.00 | −8 | 78 | −10 | 78 |
| | | 95.00 | −10 | 79 | −10 | 80 |
| Ageing study | | | | | | |
| | | Week | Aged at | Aged at | Aged at | Aged at |
| | | | R.T | 40° C. | R.T | 40° C. |
| MD elongation | | 0 | 648 | 648 | 675 | 675 |
| @break | | 2 | 554 | 126 | 549 | 433 |
| | | 4 | 590 | 120 | 635 | 243 |
| % of samples | | 0 | 100% | 100% | 100% | 675 |
| shown >100% | | 2 | 100% | 20% | 100% | 80% |
| break strain | | 4 | 100% | 40% | 100% | 40% |
| Shrink force | | 0 | 5.3 | 5.3 | 6.1 | 6.1 |
| (MPa) | | 2 | 5.4 | 4.4 | 5.7 | 6.0 |
| | | 4 | 5.7 | 5.7 | 6.3 | 6.2 |
| TD heat | | 2 | 34 | 3 | 26 | 2 |
| shrinkage @70 C. | | 4 | 28 | 4 | 22 | 4 |
| after 4 | | | | | | |
| weeks (%) | | | | | | |

### Table 17: Total Film Composition and Film Properties for Examples 20-21

### Examples 20 and 21

The composition and film properties of examples 20 and 21 are shown in the table below. Stretching conditions to make this film include a stretch temperature of 80° C., a stretch rate of 100% (mm/min), a stretch ratio of 5:1 (TD:MD), a 30 second soak time prior to stretching at the stretch temp.

Examples 21 met the requirements.

TABLE 17
Total film composition and film properties for Examples 20-21

| | | Example 20 | | Example 21 | |
|---|---|---|---|---|---|
| | | Skin | Core | Skin | Core |
| | | layer A | layer B | layer A | layer B |
| A\|B\|A layer | Resin 1 | | | | |
| composition | Resin 2 | 100 | | 100 | |
| (wt %) | Resin 3 | | 100 | | 100 |
| | Resin 4 | | | | |
| IV, Inherent viscosity | | 0.719 | | 0.717 | |
| (dL/g) | | | | | |
| Tg, Glass transition temp. | | 66.49 | | 69.66 | |
| (° C.) | | | | | |
| Strain-induced Tm (° C.) | | 205.15 | | 203.66 | |
| Composition | TPA | 100 | | 100 | |
| | (mol %) | | | | |
| | EG (mol %) | 70.03 | | 76.00 | |
| | TEG | 1.02 | | 0.75 | |
| | (mol %) | | | | |
| | NPG | 3.86 | | 7.70 | |
| | (mol %) | | | | |
| | MPDiol | 10.13 | | 4.76 | |
| | (mol %) | | | | |
| | CHDM | 7.42 | | 5.11 | |
| | (mol %) | | | | |
| | DEG | 7.54 | | 5.68 | |
| | (mol %) | | | | |
| | Temp. | MD | TD | MD | TD |
| | (° C.) | | | | |
| Heat shrinkage | 60.00 | 0 | 1 | 0 | 1 |
| (%) - no | 65.00 | 2 | 6 | 1 | 2 |
| ageing | 70.00 | 2 | 20 | 2 | 6 |
| | 75.00 | −4 | 42 | 4 | 24 |
| | 80.00 | −6 | 53 | −1 | 41 |
| | 85.00 | −4 | 68 | −8 | 59 |
| | 90.00 | −8 | 70 | −10 | 64 |
| | 95.00 | −5 | 75 | −5 | 71 |

Ageing study

| | | | | | |
|---|---|---|---|---|---|
| MD elongation | 0 | 630 | 630 | 681 | 681 |
| @break | 2 | 623 | 315 | 622 | 435 |
| % of samples | 4 | 646 | 262 | 641 | 635 |
| shown >100% | 0 | 100% | 100% | 100% | 100% |
| break strain | 2 | 100% | 60% | 100% | 80% |
| | 4 | 100% | 40% | 100% | 100%* |
| Shrink force | 0 | 6.7 | 6.7 | 7.7 | 7.7 |
| (MPa) | 2 | 7.4 | 6.2 | 6.3 | 7.5 |
| | 4 | 6.2 | 5.9 | 7.9 | 7.5 |
| TD heat | 2 | 26 | 2 | 5 | 2 |
| shrinkage @70 C. | 4 | 19 | 9 | 4 | 2 |
| after 4 weeks (%) | | | | | |

### Further Aspects and Embodiments of the Invention

In a first aspect, this disclosure provides a multilayer film comprising at least one skin layer (A) which comprises at least one polyester composition comprising:
at least one polyester which comprises:
   (a) a dicarboxylic acid component comprising:
      (i) about 90 to about 100 mole % of terephthalic acid residues;
      (ii) about 0 to about 10 mole % of aromatic and/or aliphatic dicarboxylic acid residues having up to 20 carbon atoms; and
   (b) a diol component comprising:
      about 60 mole % or greater of ethylene glycol residues and
      about 40 mole % or less of other glycols comprising one or more of:
(i) 15 mole % to less than 30 mole % of 1,4-cyclohexanedimethanol residues;
(ii) 7 mole % to less than 15 mole % of total diethylene glycol residues or butanediol residues in the final polyester composition;
wherein the total mole % of the dicarboxylic acid component is 100 mole %, and wherein the total mole % of the diol component is 100 mole %; and at least one core layer (B) which comprises a polyester composition comprising:
   a) a dicarboxylic acid component comprising:
      (i) greater than about 75 mole percent of terephthalic acid residues;
      (ii) about 0 to about 25 mole percent of aromatic and/or aliphatic dicarboxylic acid residues having up to 20 carbon atoms; and
   b) a diol component comprising:
      (i) about 60 to 90 mole percent of ethylene glycol residues; and
      (ii) about 0 to about 30 mole percent of residues chosen from neopentyl glycol, and 1,4-cyclohexanedimethanol; and
      (iii) about 0 to about 15 mole percent of diethylene glycol residues; and
      (iv) about 0 to about 35 mole percent of one or more of triethylene glycol, 1,3-propanediol, 1,4-butanediol, and 2-methyl-1,3-propanediol residues;
wherein the total mole percent of the dicarboxylic acid component is 100 mole percent, and wherein the total mole percent of the diol component is 100 percent.

In a second aspect, this disclosure provides a multilayer film comprising at least one skin layer (A) which comprises a blend of 20-99.9 wt % at least one polyester composition (1) comprising:
at least one polyester which comprises:
   (a) a dicarboxylic acid component comprising:
      (i) about 90 to about 100 mole % of terephthalic acid residues;
      (ii) about 0 to about 10 mole % of aromatic and/or aliphatic dicarboxylic acid residues having up to 20 carbon atoms; and
   (b) a diol component comprising:
      about 75 mole % or greater of ethylene glycol residues and
      about 25 mole % or less of other glycols comprising one or more of:
(i) about 5 to less than about 24 mole % of neopentyl glycol residues;
(ii) 0 to less than about 24 mole % of 1,4-cyclohexanedimethanol residues;
(iii) about 1 to less than about 15 mole % of total diethylene glycol residues or butanediol residues in the final polyester composition;
wherein the total mole % of the dicarboxylic acid component is 100 mole %, and wherein the total mole % of the diol component is 100 mole %; and 0.1-80 wt % of at least one polyester composition (2) comprising:
at least one polyester which comprises:
   (a) a dicarboxylic acid component comprising:
      (i) about 90 to about 100 mole % of terephthalic acid residues;
      (ii) about 0 to about 10 mole % of aromatic and/or aliphatic dicarboxylic acid residues having up to 20 carbon atoms; and
   (b) a diol component comprising:
      about 60 mole % or greater of ethylene glycol residues and about 40 mole % or less of other glycols comprising one or more of:
(i) 15 mole % to less than 30 mole % of 1,4-cyclohexanedimethanol residues;
(ii) 7 mole % to less than 15 mole % of total diethylene glycol residues or butanediol residues in the final polyester composition;
wherein the total mole % of the dicarboxylic acid component is 100 mole %, and wherein the total mole % of the diol component is 100 mole %; and
at least one core layer (B) which comprises a polyester composition comprising:
   i. a dicarboxylic acid component comprising:
      1. greater than about 75 mole percent of terephthalic acid residues;
      2, about 0 to about 25 mole percent of aromatic and/or aliphatic dicarboxylic acid residues having up to 20 carbon atoms; and
   ii. a diol component comprising:
      1, about 60 to 90 mole percent of ethylene glycol residues; and
      2, about 0 to about 30 mole percent of residues chosen from neopentyl glycol, and 1,4-cyclohexanedimethanol; and
      3, about 3 to about 15 mole percent of diethylene glycol residues; and
      4, about 5 to about 25 mole percent of one or more of triethylene glycol, 1,3-propanediol, 1,4-butanediol, and 2-methyl-1,3-propanediol residues;
wherein the total mole percent of the dicarboxylic acid component is 100 mole percent, and wherein the total mole percent of the diol component is 100 percent.

In a third aspect, this disclosure provides a multilayer film comprising at least one skin layer (A) which comprises a blend of 0-30 wt % at least one polyester composition (1) comprising:
at least one polyester which comprises:
   (a) a dicarboxylic acid component comprising:
      (i) about 70 to about 100 mole % of terephthalic acid residues;
      (ii) about 0 to about 30 mole % of aromatic and/or aliphatic dicarboxylic acid residues having up to 20 carbon atoms; and
   (b) a diol component comprising:
      about 75 mole % or greater of ethylene glycol residues and
      about 25 mole % or less of other glycols comprising one or more of:
(i) about 0 to less than about 24 mole % of neopentyl glycol residues;
(ii) 0 to less than about 24 mole % of 1,4-cyclohexanedimethanol residues;
(iii) 0 to less than about 24 mole % of 2-methyl-1,3-propanediol residues;
(iv) about 1 to less than about 15 mole % of total diethylene glycol residues or butanediol residues in the final polyester composition;
wherein the total mole % of the dicarboxylic acid component is 100 mole %, and wherein the total mole % of the diol component is 100 mole %; and 70-100 wt % of at least one polyester composition (2) comprising:
at least one polyester which comprises:
   (a) a dicarboxylic acid component comprising:
      (i) about 90 to about 100 mole % of terephthalic acid residues;
      (ii) about 0 to about 10 mole % of aromatic and/or aliphatic dicarboxylic acid residues having up to 20 carbon atoms; and
   (b) a diol component comprising:
      about 60 mole % or greater of ethylene glycol residues and
      about 40 mole % or less of other glycols comprising one or more of:
(i) 15 mole % to less than 30 mole % of 1,4-cyclohexanedimethanol residues;
(ii) 7 mole % to less than 15 mole % of total diethylene glycol residues or butanediol residues in the final polyester composition;
wherein the total mole % of the dicarboxylic acid component is 100 mole %, and wherein the total mole % of the diol component is 100 mole %; and at least one core layer (B) which comprises 70-100 wt % of at least one polyester composition (1) comprising: a dicarboxylic acid component comprising:
   (i) greater than about 75 mole percent of terephthalic acid residues;
   (ii) about 0 to about 25 mole percent of aromatic and/or aliphatic dicarboxylic acid residues having up to 20 carbon atoms; and
      a diol component comprising:
(i) about 60 to 90 mole percent of ethylene glycol residues; and
(ii) about 0 to about 30 mole percent of residues chosen from neopentyl glycol, and 1,4-cyclohexanedimethanol; and
(iii) about 0 to about 15 mole percent of diethylene glycol residues; and
(iv) about 0 to about 35 mole percent of one or more of triethylene glycol, 1,3-propanediol, 1,4-butanediol, and 2-methyl-1,3-propanediol residues;
   wherein the total mole percent of the dicarboxylic acid component is 100 mole percent, and wherein the total mole percent of the diol component is 100 percent; and
   0-30 wt % at least one at least one polyester composition (2) comprising:
at least one polyester which comprises:
   (a) a dicarboxylic acid component comprising:
      (i) about 70 to about 100 mole % of terephthalic acid residues;
      (ii) about 0 to about 30 mole % of aromatic and/or aliphatic dicarboxylic acid residues having up to 20 carbon atoms; and
   (b) a diol component comprising:
      about 50 mole % or greater of ethylene glycol residues and
      about 50 mole % or less of other glycols comprising one or more of:
(i) 0 mole % to less than about 50 mole % of 1,4-cyclohexanedimethanol residues;
(ii) about 0.1 mole % to less than about 15 mole % of total diethylene glycol residues in the final polyester composition;
wherein the total mole % of the dicarboxylic acid component is 100 mole %, and wherein the total mole % of the diol component is 100 mole %.

In a fourth aspect, this disclosure provides a multilayer crystallizable film comprising at least one skin layer (A) which comprises a blend of 0-30% of at one polyester composition (1) comprising:
at least one polyester which comprises:
   (a) a dicarboxylic acid component comprising:
      (i) about 70 to about 100 mole % of terephthalic acid residues;
      (ii) about 0 to about 30 mole % of aromatic and/or aliphatic dicarboxylic acid residues having up to 20 carbon atoms; and
   (b) a diol component comprising:
      about 75 mole % or greater of ethylene glycol residues and
      about 25 mole % or less of other glycols comprising one or more of:
(i) about 0 to less than about 24 mole % of neopentyl glycol residues;
(ii) 0 to less than about 24 mole % of 1,4-cyclohexanedimethanol residues;
(iii) 0 to less than about 24 mole % of 2-methyl-1,3-propanediol residues;
(iv) about 0.1 to less than about 15 mole % of total diethylene glycol residues or butanediol residues in the final polyester composition;
wherein the total mole % of the dicarboxylic acid component is 100 mole %, and wherein the total mole % of the diol component is 100 mole %;
and 70-100 wt % of at least one polyester composition (2) comprising:
at least one polyester which comprises:
   (a) a dicarboxylic acid component comprising:
      (i) about 70 to about 100 mole % of terephthalic acid residues;
      (ii) about 0 to about 30 mole % of aromatic and/or aliphatic dicarboxylic acid residues having up to 20 carbon atoms; and
   (b) a diol component comprising:
      about 75 mole % or greater of ethylene glycol residues and
      about 25 mole % or less of other glycols comprising one or more of:
(i) about 0 to less than about 24 mole % of neopentyl glycol residues;
(ii) 0 to less than about 24 mole % of 1,4-cyclohexanedimethanol residues;
(iii) 0 to less than about 24 mole % of 2-methyl-1,3-propanediol residues;
(iv) about 0.1 to less than about 15 mole % of total diethylene glycol residues or butanediol residues in the final polyester composition;
wherein the total mole % of the dicarboxylic acid component is 100 mole %, and wherein the total mole % of the diol component is 100 mole %;
   and at least one core layer (B) which comprises a blend of 0-30% of at one polyester composition (1) comprising:
at least one polyester which comprises:
   (a) a dicarboxylic acid component comprising:
      (i) about 70 to about 100 mole % of terephthalic acid residues;
      (ii) about 0 to about 30 mole % of aromatic and/or aliphatic dicarboxylic acid residues having up to 20 carbon atoms; and
   (b) a diol component comprising:
      about 75 mole % or greater of ethylene glycol residues and
      about 25 mole % or less of other glycols comprising one or more of:
(i) about 0 to less than about 24 mole % of neopentyl glycol residues;
(ii) 0 to less than about 24 mole % of 1,4-cyclohexanedimethanol residues;
(iii) 0 to less than about 24 mole % of 2-methyl-1,3-propanediol residues;
(iv) about 0.1 to less than about 15 mole % of total diethylene glycol residues or butanediol residues in the final polyester composition;
wherein the total mole % of the dicarboxylic acid component is 100 mole %, and wherein the total mole % of the diol component is 100 mole %;
and 70-100 wt % of at least one polyester composition (2) comprising:
at least one polyester which comprises:
   (a) a dicarboxylic acid component comprising:
      (i) about 70 to about 100 mole % of terephthalic acid residues;
      (ii) about 0 to about 30 mole % of aromatic and/or aliphatic dicarboxylic acid residues having up to 20 carbon atoms; and
   (b) a diol component comprising:
      about 75 mole % or greater of ethylene glycol residues and
      about 25 mole % or less of other glycols comprising one or more of:
(i) about 0 to less than about 24 mole % of neopentyl glycol residues;
(ii) 0 to less than about 24 mole % of 1,4-cyclohexanedimethanol residues;
(iii) 0 to less than about 24 mole % of 2-methyl-1,3-propanediol residues;
(iv) about 0.1 to less than about 15 mole % of total diethylene glycol residues or butanediol residues in the final polyester composition;
wherein the total mole % of the dicarboxylic acid component is 100 mole %, and wherein the total mole % of the diol component is 100 mole %; and
   wherein composition (1) is different than composition (2).

In a fifth aspect, this disclosure provides a multilayer film comprising at least one skin layer (A) which comprises a blend of 20-99.9 wt % at least one polyester composition (1) comprising:
at least one polyester which comprises:
   (a) a dicarboxylic acid component comprising:
      (i) about 70 to about 100 mole % of terephthalic acid residues;
      (ii) about 0 to about 30 mole % of aromatic and/or aliphatic dicarboxylic acid residues having up to 20 carbon atoms; and
   (b) a diol component comprising:
      about 70 mole % or greater of ethylene glycol residues and
      about 30 mole % or less of other glycols comprising one or more of:
(i) about 0 to less than about 20 mole % of neopentyl glycol residues;
(ii) 0 to less than about 5 mole % of 1,4-cyclohexanedimethanol residues; and
(iii) about 1 to less than about 5 mole % of total diethylene glycol residues or butanediol residues in the final polyester composition;
   wherein the total mole % of the dicarboxylic acid component is 100 mole %, and
   wherein the total mole % of the diol component is 100 mole %; and 0.1-80 wt % of at least one polyester composition (2) comprising:
at least one polyester which comprises:
   (a) a dicarboxylic acid component comprising:
      (i) about 90 to about 100 mole % of terephthalic acid residues;
      (ii) about 0 to about 10 mole % of aromatic and/or aliphatic dicarboxylic acid residues having up to 20 carbon atoms; and
   (b) a diol component comprising:
      about 60 mole % or greater of ethylene glycol residues and
      about 40 mole % or less of other glycols comprising one or more of:
(i) 15 mole % to less than 30 mole % of 1,4-cyclohexanedimethanol residues;
(ii) 7 mole % to less than 15 mole % of total diethylene glycol residues or butanediol residues in the final polyester composition;
wherein the total mole % of the dicarboxylic acid component is 100 mole %, and wherein the total mole % of the diol component is 100 mole %; and
at least one core layer (B) which comprises a polyester composition comprising:
   iii. a dicarboxylic acid component comprising:
      1. greater than about 70 mole percent of terephthalic acid residues;
      2, about 0 to about 30 mole percent of aromatic and/or aliphatic dicarboxylic acid residues having up to 20 carbon atoms; and
   iv. a diol component comprising:
      1, about 60 to 90 mole percent of ethylene glycol residues; and
      2, about 0 to about 30 mole percent of residues chosen from neopentyl glycol, and 1,4-cyclohexanedimethanol; and
      3, about 0 to about 15 mole percent of diethylene glycol residues; and
      4, about 0 to about 35 mole percent of one or more of triethylene glycol, 1,3-propanediol, 1,4-butanediol, and 2-methyl-1,3-propanediol residues;
wherein the total mole percent of the dicarboxylic acid component is 100 mole percent, and wherein the total mole percent of the diol component is 100 percent.

In a sixth aspect, this disclosure provides a multilayer crystallizable film comprising at least one skin layer (A) which comprises a blend of 50-99.9 wt % at least one polyester composition (1) comprising:
at least one polyester which comprises:
   (a) a dicarboxylic acid component comprising:
      (i) about 70 to about 100 mole % of terephthalic acid residues;
      (ii) about 0 to about 30 mole % of aromatic and/or aliphatic dicarboxylic acid residues having up to 20 carbon atoms; and
   (b) a diol component comprising:
      about 75 mole % or greater of ethylene glycol residues and
      about 25 mole % or less of other glycols comprising one or more of:
(i) about 0 to less than about 24 mole % of neopentyl glycol residues;
(ii) 0 to less than about 24 mole % of 1,4-cyclohexanedimethanol residues;
(iii) about 0.1 to less than about 15 mole % of total diethylene glycol residues or butanediol residues in the final polyester composition;
wherein the total mole % of the dicarboxylic acid component is 100 mole %, and wherein the total mole % of the diol component is 100 mole %; and 0.1-50 wt % of at least one polyester composition (2) comprising:
at least one polyester which comprises:
   (a) a dicarboxylic acid component comprising:
      (i) about 90 to about 100 mole % of terephthalic acid residues;
      (ii) about 0 to about 10 mole % of aromatic and/or aliphatic dicarboxylic acid residues having up to 20 carbon atoms; and
   (b) a diol component comprising:
      about 60 mole % or greater of ethylene glycol residues and
      about 40 mole % or less of other glycols comprising one or more of:
(i) 0 mole % to less than 25 mole % of 2-methyl-1,3-propanediol residues;
(ii) 0.1 mole % to less than 15 mole % of total diethylene glycol residues or butanediol residues in the final polyester composition;
wherein the total mole % of the dicarboxylic acid component is 100 mole %, and wherein the total mole % of the diol component is 100 mole %; and at least one core layer (B) which comprises a blend of 30-95 wt % of at least one polyester composition (1) comprising:
at least one polyester which comprises:
   (a) a dicarboxylic acid component comprising:
      (i) about 90 to about 100 mole % of terephthalic acid residues;
      (ii) about 0 to about 10 mole % of aromatic and/or aliphatic dicarboxylic acid residues having up to 20 carbon atoms; and
   (b) a diol component comprising:
      about 61 mole % or greater of ethylene glycol residues and
      about 39 mole % or less of other glycols comprising one or more of:
(i) about 0 to less than about 24 mole % of neopentyl glycol residues;
(ii) 0 to less than about 24 mole % of 1,4-cyclohexanedimethanol residues;
(iii) about 0.1 to less than about 15 mole % of total diethylene glycol residues or butanediol residues in the final polyester composition
wherein the total mole % of the dicarboxylic acid component is 100 mole %, and wherein the total mole % of the diol component is 100 mole %; and 5-70 wt % at least one at least one polyester composition (2) comprising:
at least one polyester which comprises:
   (a) a dicarboxylic acid component comprising:
      (i) about 70 to about 100 mole % of terephthalic acid residues;
      (ii) about 0 to about 30 mole % of aromatic and/or aliphatic dicarboxylic acid residues having up to 20 carbon atoms; and
   (b) a diol component comprising:
      about 50 mole % or greater of ethylene glycol residues and
      about 50 mole % or less of other glycols comprising one or more of:
(i) 0 mole % to less than about 50 mole % of 1,4-cyclohexanedimethanol residues;
(ii) about 0.1 mole % to less than about 15 mole % of total diethylene glycol residues or butanediol residues in the final polyester composition;
wherein the total mole % of the dicarboxylic acid component is 100 mole %, and wherein the total mole % of the diol component is 100 mole %.

In a seventh aspect, this disclosure provides a multilayer crystallizable film comprising at least one skin layer (A) which comprises a blend of 50-99.9 wt % at least one polyester composition (1) comprising:
at least one polyester which comprises:
   (a) a dicarboxylic acid component comprising:
      (i) about 70 to about 100 mole % of terephthalic acid residues;
      (ii) about 0 to about 30 mole % of aromatic and/or aliphatic dicarboxylic acid residues having up to 20 carbon atoms; and
   (b) a diol component comprising:
      about 75 mole % or greater of ethylene glycol residues and
      about 25 mole % or less of other glycols comprising one or more of:
(i) about 0 to less than about 24 mole % of neopentyl glycol residues;
(ii) 0 to less than about 24 mole % of 1,4-cyclohexanedimethanol residues;
(iii) about 0.1 to less than about 15 mole % of total diethylene glycol residues or butanediol residues in the final polyester composition;
wherein the total mole % of the dicarboxylic acid component is 100 mole %, and wherein the total mole % of the diol component is 100 mole %; and 0.1-50 wt % of at least one polyester composition (2) comprising:
at least one polyester which comprises:
   (a) a dicarboxylic acid component comprising:
      (i) about 90 to about 100 mole % of terephthalic acid residues;
      (ii) about 0 to about 10 mole % of aromatic and/or aliphatic dicarboxylic acid residues having up to 20 carbon atoms; and
   (b) a diol component comprising:
      about 60 mole % or greater of ethylene glycol residues and
      about 40 mole % or less of other glycols comprising one or more of:
(i) 0 mole % to less than 25 mole % of 2-methyl-1,3-propanediol residues;
(ii) 0.1 mole % to less than 15 mole % of total diethylene glycol residues or butanediol residues in the final polyester composition;
wherein the total mole % of the dicarboxylic acid component is 100 mole %, and wherein the total mole % of the diol component is 100 mole %; and at least one core layer (B) which comprises a blend of 30-95 wt % of at least one polyester composition (1) comprising:
at least one polyester which comprises:
   (a) a dicarboxylic acid component comprising:
      (i) about 90 to about 100 mole % of terephthalic acid residues;
      (ii) about 0 to about 10 mole % of aromatic and/or aliphatic dicarboxylic acid residues having up to 20 carbon atoms; and
   (b) a diol component comprising:
      about 61 mole % or greater of ethylene glycol residues and
      about 39 mole % or less of other glycols comprising one or more of:
(i) 0 mole % to less than 25 mole % of 2-methyl-1,3-propanediol residues;
(ii) 0.1 mole % to less than 15 mole % of total diethylene glycol residues or butanediol residues in the final polyester composition;
wherein the total mole % of the dicarboxylic acid component is 100 mole %, and wherein the total mole % of the diol component is 100 mole %; and 5-70 wt % at least one at least one polyester composition (2) comprising:
at least one polyester which comprises:
   (a) a dicarboxylic acid component comprising:
      (i) about 70 to about 100 mole % of terephthalic acid residues;
      (ii) about 0 to about 30 mole % of aromatic and/or aliphatic dicarboxylic acid residues having up to 20 carbon atoms; and
   (b) a diol component comprising:
      about 50 mole % or greater of ethylene glycol residues and
      about 50 mole % or less of other glycols comprising one or more of:
(i) 0 mole % to less than about 50 mole % of 1,4-cyclohexanedimethanol residues;
(ii) about 0.1 mole % to less than about 15 mole % of total diethylene glycol residues or butanediol residues in the final polyester composition;
wherein the total mole % of the dicarboxylic acid component is 100 mole %, and wherein the total mole % of the diol component is 100 mole %.

In an eighth aspect, this disclosure provides a film comprising a polyester which comprises:
(a) a dicarboxylic acid component comprising:
   (i) about 70 to about 100 mole % of terephthalic acid residues;
   (ii) about 0 to about 30 mole % of aromatic and/or aliphatic dicarboxylic acid residues having up to 20 carbon atoms; and
(b) a diol component comprising:
   about 60 mole % or greater of ethylene glycol residues and
   about 40 mole % or less of other glycols comprising one or more of:
(i) 0 to less than about 24 mole % of neopentyl glycol residues;
(ii) 0 to less than about 24 mole % of 1,4-cyclohexanedimethanol residues;
(iii) 0 to less than about 24 mole % of 2-methyl-1,3-propanediol residues;
(iv) about 1 to less than about 15 mole % of total diethylene glycol residues or butanediol residues in the final polyester composition;
wherein the total mole % of the dicarboxylic acid component is 100 mole %, and wherein the total mole % of the diol component is 100 mole %.

In a first embodiment, the present disclosure provides the multilayer film of any one of the first to seventh aspects or the film of the eighth aspect, wherein the multilayer film or the film is a heat shrinkable film.

In a second embodiment, the present disclosure provides an article of manufacture, a shaped article, a container, a plastic bottle, a glass bottle, packaging, a battery, a hot fill container, or an industrial article, having applied thereto a label or sleeve, wherein said label or sleeve is comprised of the heat shrinkable film of the previous embodiment.

In a third embodiment, the present disclosure provides a molded article, thermoformed sheet, extruded sheet or film comprising the multilayer film of any one of the first to seventh aspects or the film of the eighth aspect.

In a third embodiment, the present disclosure provides the heat shrinkable film of the first embodiment, which exhibits one or more of the following properties:
A. TD shrinkage @60° C.<2%;
B. TD shrinkage @65° C. between 5 and 30%;
C. TD shrinkage @95° C.>70%;
D. Shrink rate<4%/deg C. between 65 and 80° C.;
E. Shrink force<10 MPa;
F. Tg<80° C.;
G. a break strain percentage of greater than 100% at pull rates of 300 mm/minute, or 100 to 300%, or 100 to 500%, or 100 to 800%, in the transverse direction or in the machine direction or in both directions according to ASTM Method D882;
H. a break strain percentage of greater than 100% at pull rates of 300 mm/minute, or 100 to 300%, or 100 to 500%, or 100 to 800%, in the machine direction according to ASTM Method D882 after ageing after ageing the film at 40° C. for at least 3 weeks.

In a fourth embodiment, the present disclosure provides the heat shrinkable film of the first embodiment, wherein the film is stretched in at least one direction.

In a fifth embodiment, the present disclosure provides the heat shrinkable film of the first embodiment, wherein the film is stretched and oriented in at least one direction.

In a sixth embodiment, the present disclosure provides the heat shrinkable film of the first embodiment, wherein the film is annealed.

In a seventh embodiment, the present disclosure provides the heat shrinkable film of the first embodiment, wherein the film is annealed at a temperature from Tg to Tg+55° C.

In an eighth embodiment, the present disclosure provides the heat shrinkable film of the first embodiment, wherein the film has shrinkage in the main shrinkage direction of from 50% or greater when immersed in water at 85° C. for 10 seconds.

In a ninth embodiment, the present disclosure provides the heat shrinkable film of the first embodiment, wherein the film has a shrink force of less than 10 MPa.

In a tenth embodiment, the present disclosure provides the heat shrinkable film of the first embodiment, further comprising at least one voiding agent.

In an eleventh embodiment, the present disclosure provides the heat shrinkable film of the first embodiment, which is oriented in one or more directions.

In a twelfth embodiment, the present disclosure provides the heat shrinkable film of the first embodiment, wherein the film has a shrinkage in the main shrinkage direction in the amount of 50% or greater and shrinkage in the direction orthogonal to the main shrinkage direction of 10% or less when immersed in water at 95° C. for 10 seconds.

In a thirteenth embodiment, the present disclosure provides an article of manufacture, a shaped article, a container, a plastic bottle, a glass bottle, packaging, a battery, a hot fill container, or an industrial article having a label or sleeve applied thereto, said label or sleeve comprising the heat shrinkable film of the first embodiment.

In a fourteenth embodiment, the present disclosure provides the heat shrinkable film of the first embodiment, wherein the film is recyclable in a PET recycle stream.

In a fifteenth embodiment, the present disclosure provides a polyester recycle stream comprising recycled poly(ethylene terephthalate) flake, having admixed therewith at least about 0.1 weight percent of recycled film of the fourteenth embodiment.

In a sixteenth embodiment, the present disclosure provides the polyester recycle stream of the fifteenth embodiment, comprising recycled poly(ethylene terephthalate) flake, having admixed therewith at least about 0.1 weight percent of recycled shrink film, wherein said stream passes the “Critical Guidance Protocol for Clear PET Articles with Labels and Closures”, dated Apr. 11, 2019, Document No. PET-CG-02 and the “PET Flake Clumping Evaluation”, dated Nov. 1, 2022, Document No. PET-S-08.

In a seventeenth embodiment, the present disclosure provides the multilayer film of any one of the first to seventh aspects or the film of the eighth aspect, further comprising at least one polyester composition with recycle content.

In an eighteenth embodiment, the present disclosure provides the polyester composition of the seventeenth embodiment, wherein the EG residues of the polyester compositions is recycled EG.

In a nineteenth embodiment, the present disclosure provides the polyester composition of the seventeenth embodiment, wherein said terephthalic acid residues of the polyester compositions is recycled DMT.

In a twentieth embodiment, the present disclosure provides the polyester composition of the seventeenth embodiment, wherein said CHDM of the polyester compositions is recycled CHDM or the CHDM is produced from recycled DMT.

In a twenty-first embodiment, the present disclosure provides the multilayer film of any one of the first to seventh aspects or the film of the eighth aspect, wherein the inherent viscosity (IhV) of said polyester compositions range from 0.50 to 0.8 dL/g.

In a twenty-second embodiment, the present disclosure provides the multilayer film of any one of the first to seventh aspects or the film of the eighth aspect, wherein the film has a shrink force of less than 8 MPa.

In a twenty-third embodiment, the present disclosure provides the multilayer film of any one of the first to seventh aspects or the film of the eighth aspect, wherein the film has improved ageing properties and/or improved toughness.

In a twenty-fourth embodiment, the present disclosure provides the multilayer film of any one of the first to seventh aspects or the film of the eighth aspect, wherein the film has an onset of shrinkage temperature of 70° C. or lower.

In a twenty-fifth embodiment, the present disclosure provides the multilayer film of any one of the first to seventh aspects or the film of the eighth aspect, wherein the film has a rate of shrinkage between 65 and 80° C.<4.0%/deg C.

In a twenty-sixth embodiment, the present disclosure provides the multilayer film of any one of the first to seventh aspects or the film of the eighth aspect, wherein the film has ultimate shrinkage in the main shrinkage direction (transverse direction, TD) of at least have 50%.

In a twenty-seventh embodiment, the present disclosure provides the multilayer film of any one of the first to seventh aspects or the film of the eighth aspect, wherein the film has ultimate shrinkage in the main shrinkage direction (transverse direction, TD) of 70% or greater, which increases gradually with increasing temperature.

In a twenty-eighth embodiment, the present disclosure provides the multilayer film of any one of the first to seventh aspects or the film of the eighth aspect, wherein the film has negative shrinkage in the direction orthogonal to the main shrinkage direction.

In a twenty-nineth embodiment, the present disclosure provides the multilayer film of any one of the first to seventh aspects or the film of the eighth aspect, wherein the film has a break strain percentage of greater than 50% after ageing the film for 1 week at room temperature.

In a thirtieth embodiment, the present disclosure provides the multilayer film of any one of the first to seventh aspects or the film of the eighth aspect, wherein the film has a break strain percentage of greater than 100%.

In a thirty-first embodiment, the present disclosure provides the multilayer film of any one of the first to seventh aspects or the film of the eighth aspect, wherein the film has a break strain percentage of greater than 100% at a stretching speed of 300 mm/min in machine direction (MD, direction orthogonal to the main shrinkage direction) after ageing the film for 6 weeks at room temperature.

The present disclosure has been described in detail with particular reference to certain embodiments thereof, but it will be understood that variations and modifications can be effected within the spirit and scope of the invention.

What is claimed:

1. A multilayer film comprising at least one skin layer (A) which comprises a blend of 20-99.9 wt % at least one polyester composition (1) comprising:
at least one polyester which comprises:
(a) a dicarboxylic acid component comprising:
(i) about 70 to about 100 mole % of terephthalic acid residues;
(ii) about 0 to about 30 mole % of aromatic and/or aliphatic dicarboxylic acid residues having up to 20 carbon atoms; and
(b) a diol component comprising:
about 75 mole % or greater of ethylene glycol residues and
about 25 mole % or less of other glycols comprising one or more of:
(i) about 0 to less than about 24 mole % of neopentyl glycol residues;
(ii) 0 to less than about 24 mole % of 1,4-cyclohexanedimethanol residues;
(iii) about 1 to less than about 15 mole % of total diethylene glycol residues or butanediol residues in the final polyester composition;
wherein the total mole % of the dicarboxylic acid component is 100 mole %, and wherein the total mole % of the diol component is 100 mole %; and 0.1-80 wt % of at least one polyester composition (2) comprising:
at least one polyester which comprises:
(a) a dicarboxylic acid component comprising:
(i) about 90 to about 100 mole % of terephthalic acid residues;
(ii) about 0 to about 10 mole % of aromatic and/or aliphatic dicarboxylic acid residues having up to 20 carbon atoms; and
(b) a diol component comprising:
about 60 mole % or greater of ethylene glycol residues and
about 40 mole % or less of other glycols comprising one or more of:
(i) 15 mole % to less than 30 mole % of 1,4-cyclohexanedimethanol residues;
(ii) 7 mole % to less than 15 mole % of total diethylene glycol residues or butanediol residues in the final polyester composition;
wherein the total mole % of the dicarboxylic acid component is 100 mole %, and wherein the total mole % of the diol component is 100 mole %; and
at least one core layer (B) which comprises a polyester composition comprising:
(a) a dicarboxylic acid component comprising:
(i) greater than about 75 mole percent of terephthalic acid residues;
(ii) about 0 to about 25 mole percent of aromatic and/or aliphatic dicarboxylic acid residues having up to 20 carbon atoms; and
(b) a diol component comprising:
(i) about 60 to 90 mole percent of ethylene glycol residues; and
(ii) about 0 to about 30 mole percent of residues chosen from neopentyl glycol, and 1,4-cyclohexanedimethanol; and
(iii) about 0 to about 15 mole percent of diethylene glycol residues; and
(iv) about 0 to about 35 mole percent of one or more of triethylene glycol, 1,3-propanediol, 1,4-butanediol, and 2-methyl-1,3-propanediol residues;
wherein the total mole percent of the dicarboxylic acid component is 100 mole percent, and wherein the total mole percent of the diol component is 100 percent.

2. A multilayer film comprising at least one skin layer (A) which comprises at least one polyester composition comprising:
at least one polyester which comprises:
(a) a dicarboxylic acid component comprising:
(i) about 70 to about 100 mole % of terephthalic acid residues;
(ii) about 0 to about 30 mole % of aromatic and/or aliphatic dicarboxylic acid residues having up to 20 carbon atoms; and
(b) a diol component comprising:
about 75 mole % or greater of ethylene glycol residues and
about 25 mole % or less of other glycols comprising one or more of:
(i) about 0 to less than about 24 mole % of neopentyl glycol residues;
(ii) 0 to less than about 24 mole % of 1,4-cyclohexanedimethanol residues;
(iii) about 1 to less than about 15 mole % of total diethylene glycol residues or butanediol residues in the final polyester composition;
wherein the total mole % of the dicarboxylic acid component is 100 mole %, and wherein the total mole % of the diol component is 100 mole %; and
at least one core layer (B) which comprises a polyester composition comprising:
a) a dicarboxylic acid component comprising:
(i) greater than about 70 mole percent of terephthalic acid residues;
(ii) about 0 to about 30 mole percent of aromatic and/or aliphatic dicarboxylic acid residues having up to 20 carbon atoms; and
b) a diol component comprising:
(i) about 60 to 90 mole percent of ethylene glycol residues; and
(ii) about 0 to about 30 mole percent of residues chosen from neopentyl glycol, and 1,4-cyclohexanedimethanol; and
(iii) about 0 to about 15 mole percent of diethylene glycol residues; and
(iv) about 0 to about 35 mole percent of one or more of triethylene glycol, 1,3-propanediol, 1,4-butanediol, and 2-methyl-1,3-propanediol residues;
wherein the total mole percent of the dicarboxylic acid component is 100 mole percent, and wherein the total mole percent of the diol component is 100 percent.

3. The multilayer film of any one of claims 1-2, wherein said film has an A-B configuration, or wherein said film has an A-B-A configuration; or wherein said film has an A-B-A-B-A or A-A-B-A-A configuration.

4. The multilayer film of any one of claims 1-2, wherein the multilayer film is a heat shrinkable multilayer film.

5. The multilayer film of claim 4, wherein the multilayer film is stretched in at least one direction; or wherein the multilayer film is which is oriented in one or more directions; or wherein the multilayer film is stretched and oriented in at least one direction.

6. The multilayer film of claim 4, wherein the multilayer film is annealed; or wherein the multilayer film is annealed at a temperature from Tg to Tg+55° C.

7. The multilayer film of claim 4, wherein the multilayer film has shrinkage in the main shrinkage direction of from 50% or greater when immersed in water at 85° C. for 10 seconds; or wherein the multilayer film has a shrinkage in the main shrinkage direction in the amount of 50% or greater and shrinkage in the direction orthogonal to the main shrinkage direction of 10% or less when immersed in water at 95° C. for 10 seconds.

8. The multilayer film of claim 4, wherein the multilayer film has a shrink force of less than 10 MPa; or wherein the multilayer film has a shrink force of less than 8 MPa.

9. The multilayer film of any one of claims 1-2, further comprising at least one voiding agent.

10. An article of manufacture, a shaped article, a container, a plastic bottle, a glass bottle, packaging, a battery, a hot fill container, or an industrial article having a label or sleeve applied thereto, said label or sleeve comprising the multilayer film of any one of claims 1-9.

11. The multilayer film of any one of claims 1-2, wherein the layer (A) of the multilayer film has a crystalline melting point of 190° C. to 225° C., or of 190° C. to 245° C., or of 150° C. to 245° C.

12. The multilayer film of any one of claims 1-11, wherein the multilayer film is recyclable in a PET recycle stream.

13. A polyester recycle stream comprising recycled poly(ethylene terephthalate) flake, having admixed therewith at least about 0.1 weight percent of recycled multilayer film of any one of claims 1-12.

14. The polyester recycle stream of claim 13, comprising recycled poly(ethylene terephthalate) flake, having admixed therewith at least about 0.1 weight percent of multilayer recycled shrink film, wherein said stream passes the “Critical Guidance Protocol for Clear PET Articles with Labels and Closures”, dated Apr. 11, 2019, Document No. PET-CG-02, and the “PET Flake Clumping Evaluation”, dated Nov. 1, 2022, Document No. PET-S-08.

15. The multilayer film of any one of claims 1-2, further comprising at least one polyester composition with recycle content.

16. The multilayer film of claim 15, wherein the EG residues of the polyester compositions is recycled EG; or wherein the terephthalic acid residues of the polyester compositions is recycled DMT; or wherein the CHDM of the polyester compositions is recycled CHDM or the CHDM is produced from recycled DMT.

17. The multilayer film of any one of claims 1-2, wherein the inherent viscosity (IhV) of the polyester compositions range from 0.50 to 0.8 dL/g.

18. The multilayer film of any one of claims 1-2, wherein the film has less than 1% PET clumping when heated as a 3% blend with rPET for 90 minutes at a temperature between 150-220° C.

19. The multilayer film of claim 4, wherein the multilayer film has a break strain percentage of greater than 100% at a stretching speed of 300 mm/min in machine direction (MD, direction orthogonal to the main shrinkage direction) after ageing the film for 6 weeks at room temperature.

20. The heat shrinkable multilayer film of claim 4, which exhibits one or more of the following properties:
A. TD shrinkage @60° C.<2%;
B. TD shrinkage @65° C. between 2 and 30%;
C. TD shrinkage @95° C.>70%;
D. Shrink rate<4%/deg C. between 65 and 80° C.;
E. Shrink force<10 MPa;
F. Tg<80° C.;
G. a break strain percentage of greater than 100% at pull rates of 300 mm/minute, or 100 to 300%, or 100 to 500%, or 100 to 800%, in the transverse direction or in the machine direction or in both directions according to ASTM Method D882;
H. a break strain percentage of greater than 100% at pull rates of 300 mm/minute, or 100 to 300%, or 100 to 500%, or 100 to 800%, in the machine direction according to ASTM Method D882 after ageing after ageing the film at 40° C. for at least 3 weeks.
